(19) United States
(12) Patent Application Publication
(10) Pub. No.: US 2008/0059329 A1
(43) Pub. Date: Mar. 6, 2008

(54) SYSTEMS AND METHODS WHEREIN A TRANSFER CODE FACILITATES A TRANSACTION BETWEEN A SELLER AND A BUYER

(76) Inventors: Andrew S. Van Luchene, Norwalk, CT (US); Jay S. Walker, Ridgefield, CT (US); Geoffrey M. Gelman, Stamford, CT (US); Kathleen Van Luchene, Norwalk, CT (US); Deirdre O'Shea, New York, NY (US)

Correspondence Address: WALKER DIGITAL MANAGEMENT, LLC, 2 HIGH RIDGE PARK, STAMFORD, CT, 06905, US

(21) Appl. No.: 11/928,085

(22) Filed: Oct. 30, 2007

Related U.S. Application Data
(62) Division of application No. 09/589,059, filed on Jun. 8, 2000, now Pat. No. 6,473,111.
(60) Provisional application No. 60/183,900, filed on Feb. 22, 2000.

(51) Int. Cl. G06Q 30/00

(52) U.S. Cl. 705/26

(57) ABSTRACT

Systems and methods are provided to facilitate a transaction between a seller interested in selling an item and a buyer interested in making a purchase. According to one embodiment, a transfer code is transmitted to the buyer. The transfer code is then received from the seller as an indication that the buyer has received the item. After the transfer code is received, it may be arranged for the seller to receive payment in exchange for providing the item to the buyer. In another embodiment, it is arranged for the buyer to purchase the item from the seller, and a transfer code is transmitted to the seller. In this case, the transfer code may be received from the buyer as an indication that he or she has received the item from the seller. According to another embodiment, a delivery code is received from the seller after it is arranged for the buyer to purchase the item. After the delivery code is received, it is arranged for the seller to receive payment in exchange for providing the item to the buyer.

### CROSS REFERENCE TO RELATED APPLICATIONS

The present application is a divisional application of U.S. patent application Ser. No. 09/589,059 filed on Jun. 20, 2000, which claims the benefit of U.S. Provisional Patent Application No. 60/183,900 filed Feb. 22, 2000, the entire content of which are incorporated by reference herein.

The present application is related to U.S. patent application Ser. No. 09/586,742 entitled “Systems and Methods for Facilitating a Transaction By Matching Seller Information and Buyer Information” and filed Jun. 5, 2000; U.S. patent application Ser. No. 08/964,967 entitled “Conditional Purchase Offer (CPO) Management System for Collectibles” and filed Nov. 5, 1997, which is a continuation-in-part of U.S. patent application Ser. No. 08/889,319 entitled “Conditional Purchase Offer Management System” and filed Jul. 8, 1998, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 09/282,747 entitled “Method and Apparatus for Providing Cross-Benefits Based on a Customer Activity” and filed Mar. 31, 1999; U.S. patent application Ser. No. 09/274,281 entitled “Method and Apparatus for Providing Cross-Benefits via a Central Authority” and filed Mar. 22, 1999; U.S. patent application Ser. No. 09/322,351 entitled “Method and Apparatus for Providing Cross Benefits and Penalties” and filed May 28, 1999; U.S. patent application Ser. No. 09/100,684 entitled “Billing Statement Customer Acquisition System” and filed Jun. 19, 1999, which is a continuation-in-part of U.S. patent application Ser. No. 08/982,149 entitled “Method and Apparatus for Printing a Billing Statement to Provide Supplementary Product Sales” and filed on Dec. 1, 1997. The entire contents of these applications are incorporated herein by reference.

### FIELD OF THE INVENTION

The present invention relates to commerce. In particular, the present invention relates to systems and methods for facilitating a transaction between a seller and a buyer.

### BACKGROUND OF THE INVENTION

Many consumers are interested in selling items. A consumer may, for example, be interested in selling a used or second-hand item (i.e., a “secondary market” item) that he or she owns but no longer uses. Consumer electronics, exercise equipment, automobiles and collectibles (e.g., coins or stamps) are some examples of secondary market items. Similarly, a consumer may be interested in selling, for example, a theater or airline ticket that he or she will not be able to use.

One way for a consumer to sell an item is through a merchant who in turn re-sells the item to another consumer. Such a merchant, however, will want to profit from the transaction, or at least pay for overhead associated with the transaction (e.g., employee salaries, rent, insurance). As a result, an item price the consumer may receive from the merchant in exchange for selling the item is generally less than an item price another consumer will be willing to provide to the merchant in exchange for the item.

Moreover, a merchant who deals with a large number of consumers may not be flexible with respect to one or more transaction terms. For example, the merchant may insist that every consumer bring his or her items directly to the merchant. A consumer may, however, prefer that a buyer pick up an item from his or her home. For example, a consumer may prefer that a buyer pick up a heavy piece of exercise equipment. Another consumer may prefer to meet a buyer at a mutually convenient location to complete a transaction (e.g., to maintain his or her anonymity). It will typically not be practical for a merchant to individually negotiate delivery terms, or other transaction terms, with each consumer.

Another problem with selling an item to a merchant is that a consumer may not be able to determine a reasonable price for the item. That is, a merchant will typically set the item price, and the consumer may have no way of knowing if the merchant's item price is reasonable. Although the consumer could bring the item to a number of different merchants to determine a reasonable price (e.g., by comparing item prices set by different merchants), such a solution would be inconvenient and time consuming.

In addition to selling items, many consumers are interested in purchasing items, such as secondary market items. Purchasing such items from merchants, however, may involve the same disadvantages as described above with respect to the sale of such items. Namely, a merchant may increase an item price and may not be flexible with respect to transaction terms. Moreover, a merchant typically determines an item price, and a consumer interested in purchasing the item may not be able to determine if the item price is reasonable.

As a result of these disadvantages, many consumers are interested in completing transactions directly with other consumers. Because no third party needs to make a profit, or pay for overhead, both the seller and the buyer can often benefit from such a direct “consumer-to-consumer” transaction. Moreover, both parties can work together to decide on agreeable terms for the transaction, such as mutually convenient delivery terms.

To help facilitate consumer-to-consumer transactions, “on-line” services that communicate with a large number of sellers and buyers, such as World Wide Web sites provided via the Internet, have become increasingly popular.

In a classified advertisement, or “classifieds,” type of on-line service, a seller can advertise an item to be sold at a particular price. When a buyer agrees to purchase the item at that price, the item is sold to the buyer. The advertisement may include, for example, a description of the item and an item price. A buyer can similarly advertise that he or she is interested in purchasing a particular type of item.

In an “auction” type of on-line service, a seller posts an item to be sold by auction. A post for an auction may include, for example, an item description but not an item price. A number of buyers may submit bids for that item, and the item is sold to the bidder that submits the highest bid. Such an auction type of on-line service can also let a seller set a “floor price” for the item. That is, the item will not be sold below the floor price even if no higher bids are submitted.

In addition to the classifieds and auction types of services, U.S. patent application Ser. No. 08/964,967, entitled “Conditional Purchase Offer (CPO) Management System for Collectibles,” discloses a system wherein a CPO management system receives a Conditional Purchase Offer (CPO) from a buyer. The buyer's CPO is a binding offer containing one or more conditions submitted by a buyer for the purchase of an item at a buyer-defined price. The CPO management system then determines whether one or more sellers are willing to accept the buyer's CPO. If a seller accepts the buyer's CPO, and ultimately delivers an item complying with the conditions, the buyer is bound to provide payment of the buyer-defined price. The buyer's CPO may be guaranteed, for example, by a credit card account.

With the consumer-to-consumer services described above, however, it may be difficult for a buyer and a seller to complete a transaction. For example, some services require the buyer and the seller to decide how a transaction should be completed (e.g., how an item should be transferred to the buyer and how the seller should receive payment for the item). Such an approach, however, can result in fraudulent behavior. For example, a buyer may send a money order to a seller, but the seller may fail to send the item to the buyer. Similarly, a seller may attempt to sell a defective or otherwise deficient item to the buyer.

Even if a service attempts to reduce fraudulent behavior, it may be difficult for the service to determine if and when a seller has actually transferred an item to a buyer. For example, a buyer might claim that he or she never received an item, while the seller claims that the item was in fact provided to the buyer.

Another problem with known consumer-to-consumer services is that a party may initiate, but not complete, a transaction. For example, a buyer may contact a seller who advertised that he or she was interested in selling four tickets to a particular concert only to find out that the seller had already sold the tickets to someone else. Similarly, a seller may back-out of a transaction for any number of other reasons (e.g., if the seller and the buyer are unable to agree on a transaction term, such as a delivery term).

Another problem with known services is a buyer typically is not protected after a transaction is completed. For example, a buyer may purchase a lawnmower only to find that it does not work properly on warm days. In this case, the buyer may not be able to receive a refund from the seller via the service.

Moreover, known services typically offer only a limited amount of protection with respect to the privacy of a buyer and/or a seller. For example, the buyer and the seller may be required to communicate directly with each other via e-mail messages. Some people, however, may prefer to not communicate directly with an unknown person.

Note that businesses face many of the same problems discussed above with respect to consumers. For example, a business interested in selling items to, or purchasing items from, consumers—or even a business interested in selling items to, or purchasing items from, other businesses—may find it difficult to complete a transaction.

Thus, a need exists for improved systems that facilitate transactions between buyers and sellers.

### SUMMARY OF THE INVENTION

To alleviate problems inherent in the prior art, the present invention introduces systems and methods to facilitate a transaction between a seller and a buyer.

According to one embodiment of the present invention, a transfer code is transmitted to a buyer. The transfer code is received from a seller as an indication that the buyer has received an item. After the transfer code is received, it is arranged for the seller to receive payment in exchange for providing the item to the buyer.

According to another embodiment, it is arranged for a buyer to purchase an item from a seller. A transfer code is transmitted to the buyer after the buyer has provided payment for the item. After the transfer code is received from the seller as an indication that the buyer has received the item, it is arranged for the seller to receive payment in exchange for providing the item to the buyer.

According to another embodiment, a first transfer code is transmitted to a buyer. A second transfer code is received from a seller as an indication that the buyer has received an item, the second transfer code being associated with the first transfer code. After the second transfer code is received, it is arranged for the seller to receive payment in exchange for providing the item to the buyer.

According to another embodiment, a buyer arranges via a controller to purchase an item from a seller. After arranging to provide payment for the item, the buyer receives a transfer code from the controller. The buyer receives the item from the seller and provides the transfer code to the seller as an indication that the seller has provided the item.

According to another embodiment, a seller arranges via a controller to sell an item to a buyer. After providing the item to the buyer, the seller receives a transfer code from the buyer and transmits the transfer code to the controller as an indication that the item has been received by the buyer. After transmitting the transfer code, the seller receives payment in exchange for providing the item to the buyer.

According to another embodiment, it is arranged for a buyer to purchase an item from a seller. After receiving a delivery code from the seller, it is arranged for the seller to receive payment in exchange for providing the item to the buyer. The delivery code may be verified, such as by verifying the delivery code based on information received from a delivery service.

According to another embodiment, information is received associated with a transaction between a seller interested in selling an item and a buyer interested in making a purchase. A transfer code is transmitted to the buyer after the buyer has provided payment for the item, and the transfer code is received from the seller as an indication that the buyer has received the item. After receiving the transfer code from the seller, it is arranged for the seller to receive payment in exchange for providing the item to the buyer.

According to another embodiment, an indication of a first preferred method of delivery is received from the seller. An indication of a second preferred method of delivery is received from the buyer. Based on the first preferred method of delivery and the second preferred method of delivery, it is arranged for the buyer to purchase the item from the seller.

According to another embodiment, it is arranged for a buyer to purchase an item from a seller. Complaint information is received from at least one of the buyer and the seller. Based on the received complaint information, a penalty is applied to at least one of the buyer and the seller.

One embodiment of the present invention comprises: means for transmitting a transfer code to the buyer; means for receiving the transfer code from the seller as an indication that the buyer has received the item; and means for arranging, after said receiving, for the seller to receive payment in exchange for providing the item to the buyer.

With these and other advantages and features of the invention that will become hereinafter apparent, the nature of the invention may be more clearly understood by reference to the following detailed description of the invention, the appended claims and the several drawings attached herein.

### BRIEF DESCRIPTION OF THE DRAWINGS

FIG. 1 is a flow diagram of a transaction performed according to an embodiment of the present invention.

FIG. 2 is a flow chart of a transaction method according to an embodiment of the present invention.

FIG. 3 is a flow diagram of a transaction performed according to another embodiment of the present invention.

FIG. 4 is a flow chart of a transaction method according to another embodiment of the present invention.

FIG. 5 is a flow diagram of a transaction performed according to another embodiment of the present invention.

FIG. 6 is a flow chart of a transaction method according to another embodiment of the present invention.

FIG. 7 is a block diagram overview of a transaction system according to an embodiment of the present invention.

FIG. 8 is a block diagram of a controller according to an embodiment of the present invention.

FIG. 9 is a tabular representation of a portion of a buyer database according to an embodiment of the present invention.

FIG. 10 is a tabular representation of a portion of a seller database according to an embodiment of the present invention.

FIG. 11 is a tabular representation of a portion of an offer to buy database according to an embodiment of the present invention.

FIG. 12 is a tabular representation of a portion of an offer to sell database according to an embodiment of the present invention.

FIG. 13 is a tabular representation of a portion of a transaction database according to an embodiment of the present invention.

FIG. 14 is a tabular representation of a portion of a transaction claim database according to an embodiment of the present invention.

FIG. 15 is a map illustrating locations at which an item may be transferred according some embodiments of the present invention.

FIG. 16 is a flow chart of a method according to an embodiment of the present invention.

FIG. 17 is a table illustrating transfer types and preferences according to an embodiment of the present invention.

FIG. 18 is a flow chart of a method performed when an offer to sell is bound with an offer to buy according to an embodiment of the present invention.

FIG. 19 is a flow chart of a method performed when an offer to sell is bound with an offer to buy according to another embodiment of the present invention.

FIG. 20 is a flow chart of a method performed when an offer to sell is bound with an offer to buy according to another embodiment of the present invention.

### DETAILED DESCRIPTION

The present invention is directed to systems and methods for facilitating a transaction between a seller and a buyer. According to one embodiment, a controller receives seller offer information, such as an Offer To Sell (OTS), from a seller. The seller may be, for example, an individual or a business who is interested in selling an item. The item may be, by way of example, any product or service, such as a secondary market item, computer software, a ticket, a future product (e.g., a book to be released on a future date), a hotel room reservation, or a gift certificate. The OTS may include, for example, a seller price and information describing the item.

The controller also receives buyer offer information, such as an Offer To Buy (OTB), from a buyer. The buyer may be, for example, an individual or a business who is interested in making a purchase. For example, the buyer may be interested in purchasing an item or purchasing a right to an item (e.g., renting or licensing the item). The OTB may include, for example, a buyer price and an item category (e.g., medium screen televisions or 35 mm cameras).

The controller may “match” the OTS and the OTB and arrange for the seller to sell the item to the buyer. An OTB may be matched with an OTS based on, for example, the item category associated with the OTB, the information describing the item associated with the OTS, the buyer price, and the seller price. As used herein, a matching offer may be an OTS that matches an OTB or an OTB that matches an OTS.

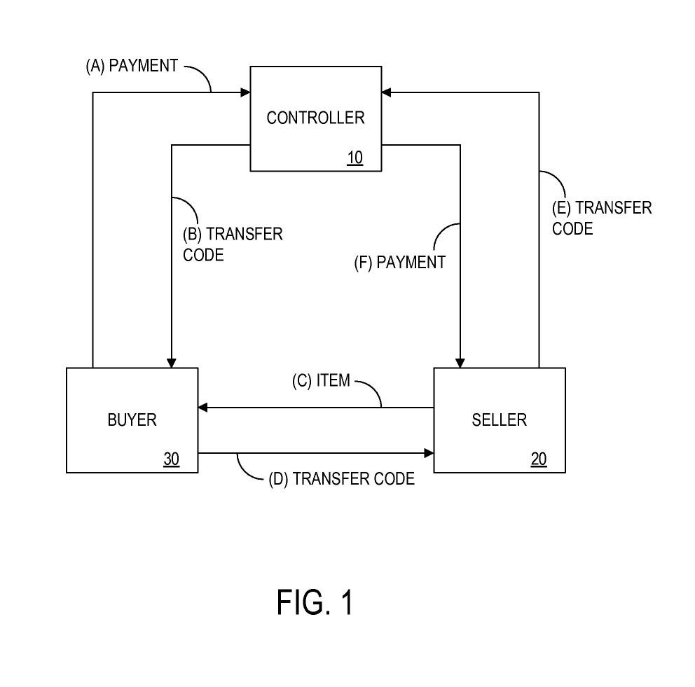

Referring in detail to the drawings, FIG. 1 is a flow diagram of a transaction performed according to an embodiment of the present invention. In particular, the transaction involves a controller 10 that facilitates the sale of an item from a seller 20 to a buyer 30.

By way of example, the seller 20 may have submitted an OTS to the controller 10 describing a particular television he or she is interested in selling (e.g., including a manufacturer, a model number, and a minimum acceptable seller price). Similarly, the buyer 30 may have submitted an OTB to the controller 10 (e.g., an offer to buy a 32 inch screen television for a maximum buyer price). After matching the OTS and the OTB, the controller 10 arranges for the buyer to provide payment for the item at (A). For example, the controller 10 may charge an amount based on the buyer price to a credit card account associated with the buyer 30.

After receiving payment from the buyer 30, the controller provides a “transfer code” to the buyer 30 at (B). The transfer code may be, for example, an alphanumeric code such as “TC4096” or “WILDFIRE” transmitted to the buyer 30 via an e-mail message.

In addition to providing the transfer code to the buyer 30, the controller 10 may arrange for the seller 20 and the buyer 30 to meet at a mutually convenient location to transfer the item. For example, the controller 10 may instruct the seller 20 and the buyer 30 to meet in a train station parking lot at a particular date and time to transfer the item.

At (C), the seller 20 provides the item to the buyer 30. After receiving the item, the buyer 30 provides the transfer code to the seller at (D). For example, the buyer 30 may inspect the item and, if satisfied, verbally provide the transfer code to the seller 20.

The seller 20 then provides the transfer code to the controller 10 at (E). For example, the seller 20 may return home and transmit the transfer code to the controller 10 via an e-mail message. After receiving the transfer code, the controller 10 arranges for the seller 20 to receive payment in exchange for the item at (F). For example, the controller 10 may credit an amount based on the seller price to a credit card account associated with the seller 20.

According to another embodiment, the buyer 30 generates the transfer code instead of the controller 10. In this case, the buyer 30 may provide the transfer code to the controller 10 and the seller 20. The controller 10 can the compare the transfer code received from the buyer 30 with a transfer code received from a seller 20 to determine that the seller 20 has provided the item to the buyer 30.

According to another embodiment, the transfer code provided from the controller 10 to the buyer 30, from the buyer 30 to the seller 20, and from the seller 20 to the controller 10 may not be identical. For example, the seller 20 may receive a first transfer code from the buyer 30. The seller 20 may then modify the first transfer code (e.g., by adding a seller identifier) before communicating with the controller 10.

According to another embodiment, the seller 20 and the buyer 10 communicate anonymously via the controller 10. For example, the seller 20 may simply be told that a buyer 30 will be present at a meeting location. In this case, the buyer 30 may provide his or her name or identifier to the seller 20 as a transfer code.

According to another embodiment, payment may be provided to the seller 20 before he or she provides the item to the buyer 30. In this case, a penalty may be applied to the seller 20 if he or she does not transmit a transfer code to the controller 10 within a predetermined period of time.

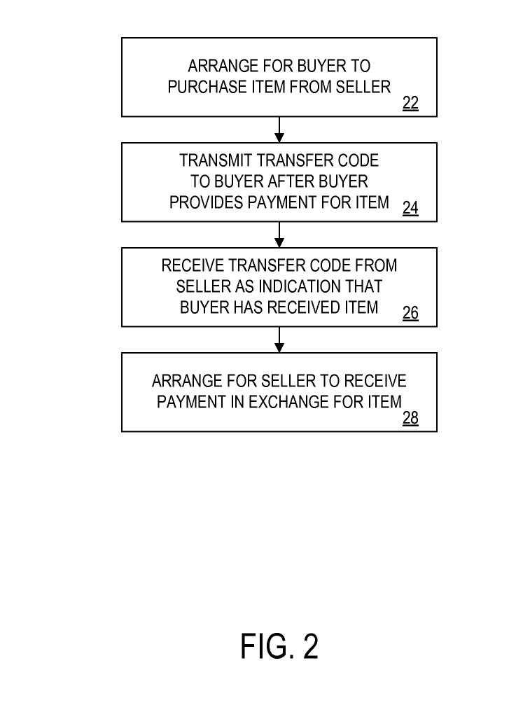

FIG. 2 is a flow chart of a transaction method that may be performed by the controller 10 of FIG. 1 according to an embodiment of the present invention. At 22, the controller 10 arranges for a buyer 30 to purchase an item (e.g., a secondary market item) from a seller 20. The controller 10 may arrange for the buyer 30 to purchase the item from the seller via, for example: (i) a Web site, (ii) the Internet, (iii) a Personal Computer (PC), (iv) a Personal Digital Assistant (PDA), (v) a kiosk, (vi) an Automated Teller Machine (ATM), (vii) an e-mail message, (viii) a telephone, (ix) an Interactive Voice Response Unit (IVRU), and/or (x) an operator (e.g., a telephone call center operator). For example, the controller 10 may receive seller offer information associated with the item (e.g., an OTS) and buyer offer information associated with the buyer 30 (e.g., an OTB) via a Web site. According to one embodiment, the seller offer and/or the buyer offer may be “binding” (e.g., the seller 20 and/or the buyer 30 may be obligated to complete the transaction when an appropriate match is found by the controller 10).

The controller 10 may then match the seller offer information and the buyer offer information. For example, the controller 10 may match an OTB submitted by the buyer 30 with an OTS submitted by the seller 20. The matching may be based on, for example, at least one of: (i) an item category, (ii) at least one item feature, (iii) an item price, (iv) an age associated with the item, (v) an item manufacturer, (vi) an item description, (vii) an item image, (viii) an item condition, (ix) an item preference, (x) a transaction period, (xi) delivery information, and/or (xii) payment information.

The matching may also be based on a buyer address and a seller address. For example, the controller 10 may only match an OTS with an OTB when it is convenient for the seller 20 to transfer the item to the buyer 30 in person. For example, the matching may be based on whether or not the seller address and the buyer address are within a predetermined distance of a third party address (e.g., a MCDONALD'S® restaurant). According to another embodiment, the controller 10 may instead arrange for the seller 20 to ship the item to the buyer 30.

The controller 10 may also arrange for the buyer 30 to provide payment for the item. For example, the controller 10 may arrange for the buyer 30 to provide payment via: (i) a credit card account associated with the buyer 30, (ii) a debit card account associated with the buyer 30, (iii) a checking account associated with the buyer 30, and/or (iv) a digital payment protocol.

At 24, the controller 10 transmits a transfer code to the buyer 30 after the buyer has provided payment for the item. As used herein, a transfer code may be any information associated with a transaction, such as an alphanumeric code uniquely associated with the transaction or a code associated with a party (e.g., the buyer and/or the seller). The transfer code may be based on, for example: (i) a buyer identifier, (ii) a seller identifier, (iii) a transaction identifier, (iv) an item identifier, (v) a date, (vi) delivery information, and/or (vii) payment information.

The controller 10 may transmit the transfer code to the buyer, for example, via: (i) a Web site, (ii) the Internet, (iii) a PC, (iv) a PDA, (v) a kiosk, (vi) an ATM, (vii) an e-mail message, (viii) a telephone, (ix) an IVRU, and/or (x) an operator.

According to one embodiment, the controller 10 transmits the transfer code to the buyer 30 in a human-recognizable format. For example, the controller 10 may display a code word on a Web site (e.g., enabling the buyer 30 to write down the code word or generate a copy of the Web site using a printer coupled to his or her PC).

According to one embodiment of the present invention, the transfer code comprises a “hash” value generated when transaction information is used with a hash function, such as a one-way hash function. A hash function is a transformation that takes input information and returns a hash value. In general, one can think of a hash value as a “digital fingerprint” of the input information. For example, the input information to the hash function may be the buyer's name and address and information about the item (e.g., an item identifier). In this case, the hash function would generate the transfer code based on the input information. The controller 10 and/or a seller device could then validate the transfer code using an appropriate function. Applicable hash functions and other encryption techniques are described in Bruce Schneier, “Applied Cryptography: Protocols, Algorithms, and Source Code in C” (John Wiley & Sons, Inc., 2nd Ed. 1996).

According to one embodiment of the present invention, the transfer code is transmitted to a buyer device. For example, the transfer code may be transmitted to a buyer's PDA (e.g., via the buyer's PC and a docking station). As another example, the controller 10 may store a representation of the transfer code using the buyer's PC, such as by storing the representation as a “cookie.” A cookie may be a block of data that a Web server (e.g., the controller 10) stores on a client system (e.g., a buyer device). When the buyer 30 returns to the same Web site, or an associated Web site, the browser of the buyer device sends a copy of the cookie back to the Web server. Cookies may be used to identify buyers associated with a buyer device, to instruct the Web server to send a customized version of a Web page, to store and/or transmit transfer codes, and for other purposes. Note that the transfer code may, according to one embodiment of the present invention, be generated by a buyer device, such as the buyer's PC (e.g., instead of being transmitted from the controller 10 to the buyer 30).

The seller 20 then transfers the item to the buyer 30. For example, the seller 20 and the buyer 30 may meet in person to transfer the item. In this case, the seller 20 may provide the item to the buyer 30. The buyer 30 may then inspect the item and provide the transfer code to the seller 20 (e.g., by providing the transfer code verbally to the seller 20 or by transmitting the transfer code from a buyer device to a seller device via an IR communication link).

According to one embodiment of the present invention, the seller 20 may have received verification information from the controller 10 prior to meeting the buyer 30. For example, the controller 10 may have transmitted the first four digits of a sixteen digit transfer code to the seller 20. Similarly, the verification information may represent the sum of each of the digits in the transfer code. In this way, the seller 20 can compare the transfer code and the verification information to determine that he or she it transferring the item to the appropriate person. As another example, a transfer code may be represent a specific member of a set identified by a verification code (e.g., “collie” and “dog” or “Florida” and “U.S. state”).

According to another embodiment, the seller 20 sends a verification request to the controller 10 while exchanging the item with the buyer. For example, the seller 20 may use his or her wireless telephone to transmit a transfer code to the controller 10 for verification.

At 26, the controller 10 receives the transfer code from the seller 20 as an indication that the buyer 30 has received the item. For example, the seller 20 may have received the transfer code from the buyer 30 when he or she provided the item to the buyer (e.g., either in person or via a delivery service). According to one embodiment, the seller 20 may transmit the transfer code to the controller 10 in human-recognizable format (e.g., by reading the transfer code to a telephone call center operator or by typing a four digit transfer code via an ATM device). According to another embodiment, the controller 10 receives the transfer code from a seller device (e.g., the seller's PDA).

The controller 10 may then verify the transfer code received from the seller 20. For example, the controller 10 may compare the received transfer code with a list of valid transfer codes associated with the seller (e.g., when the seller has arranged to sell more than one item via the controller 10) or use a hash function to analyze the transfer code.

According to one embodiment, the controller 10 arranges for the seller 20 to receive a “prompt” when the transfer code has not been received for a predetermined period of time. As used herein, a prompt may be, for example, a reminder or warning provided to a buyer or seller indicating that he or she should perform an action (e.g., provided via an e-mail message, a Web site, a telephone call, a message printed on a receipt, or postal mail). For example, if the controller arranged for the buyer 30 and the seller 20 to meet on January 15^{th} to transfer the item, the controller 10 may send an e-mail message to the seller 20 on January 17^{th} reminding him or her to supply the transfer code (assuming that the seller 20 has not already transmitted the appropriate transfer code). According to one embodiment, the controller 10 may apply a penalty to the seller 20 if the transfer code is not received within a predetermined period of time.

At 28, the controller 10 arranges for the seller 20 to receive payment in exchange for providing the item to the buyer 30. For example, the controller 10 may arrange for the seller 20 to receive payment via: (i) a credit card account associated with the seller 20, (ii) a debit card account associated with the seller 20, (iii) a checking account associated with the seller 20, and/or (iv) a digital payment protocol.

Note that the payment received from the buyer 30 may not equal the payment provided to the seller 20. For example, the buyer 30 may have offered to pay $200 for a concert ticket and the seller 20 may have offered to sell such a ticket for $185. In this case, the controller 10 may keep the difference between these amounts (i.e., $15) in exchange for facilitating the transaction. According to another embodiment, the controller 10 may charge a fee (e.g., a predetermined amount or a percentage of a payment amount) to the buyer 30 and/or the seller 20 in exchange for performing this service. In this case, the seller 20 may receive payment of the full amount paid by the buyer 30.

According to one embodiment of the present invention, the controller 10 may also receive complaint information from the buyer 30. For example, the buyer 30 may indicate that a television that he or she received from a seller 20 does not work properly. In this case, the controller 10 may arrange for the buyer 30 to return the item to the seller 20 and/or apply a penalty to the seller 20 based on the complaint information. Similarly, the controller 10 may receive complaint information from the seller (e.g., indicating that the buyer did not show up at a pre-arranged meeting to transfer the item) and/or apply a penalty to the buyer based on the complaint information.

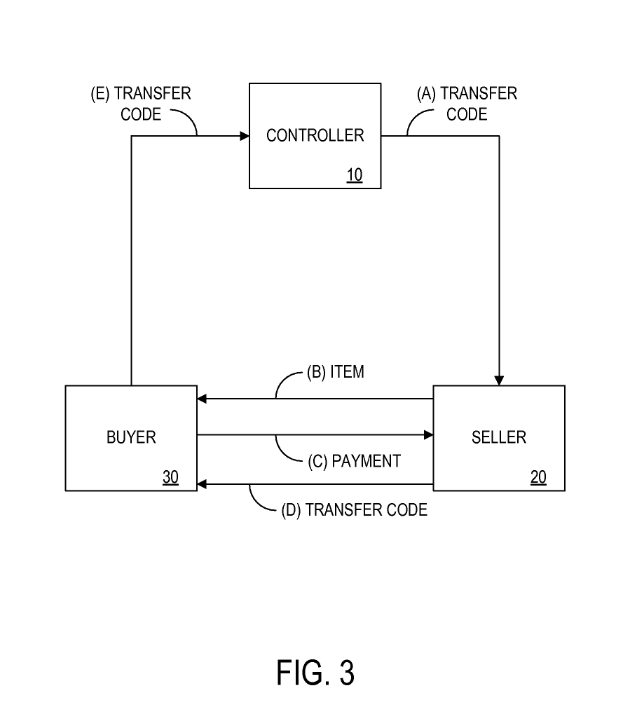

FIG. 3 is a flow diagram of a transaction performed according to another embodiment of the present invention. As before, the controller 10 arranges for a buyer 30 to purchase an item from a seller 20. In this case, however, the controller 10 provides a transfer code to the seller 20 at (A) and arranges for the seller to provide the item to the buyer (e.g., in person or via a delivery service). The seller 20 provides the item to the buyer 30 at (B) and receives payment from the buyer 30 at (C). After receiving payment, the seller 20 provides the transfer code to the buyer 30 at (D). The buyer 30 then provides the transfer code to the controller 10 at (E) to indicate that the transaction has been completed. Such an embodiment places the burden of indicating that the transaction has been completed on the buyer 30 instead of the seller 20. In this case, the controller 10 may prompt the buyer 30 if the transaction code has not been received within a predetermined period of time (e.g., within one week of the arranged transfer of the item).

According to another embodiment, the seller 20 may generate a transfer code and provide the code to the controller 10 and the buyer 30.

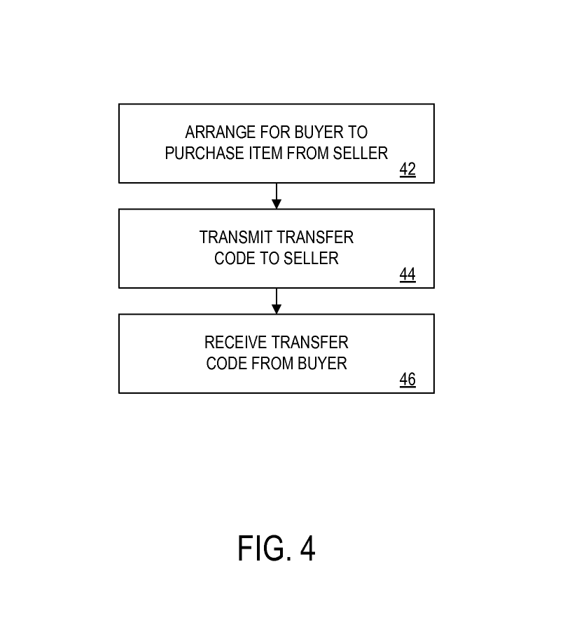

FIG. 4 is a flow chart of a transaction method that may be performed by the controller 10 of FIG. 3. Note that various embodiments of the present invention described with respect to FIG. 2 are also applicable to the method illustrated in FIG. 4. At 42, the controller 10 arranges for the buyer 30 to purchase the item from the seller 20. For example, the controller 10 may match an OTB associated with the buyer 30 with an OTS associated with the seller 20.

At 44, the controller 10 transmits a transfer code to the seller 20. For example, the controller 10 may transmit a four digit number to the seller 20 via an e-mail message. In this case, the seller 20 may provide the transfer code to the buyer 30 along with the item. At 46, the controller 10 receives the transfer code from the buyer 30 indicating that the transaction has been completed (e.g., including the fact that the seller 20 provided an appropriate payment to the buyer 30).

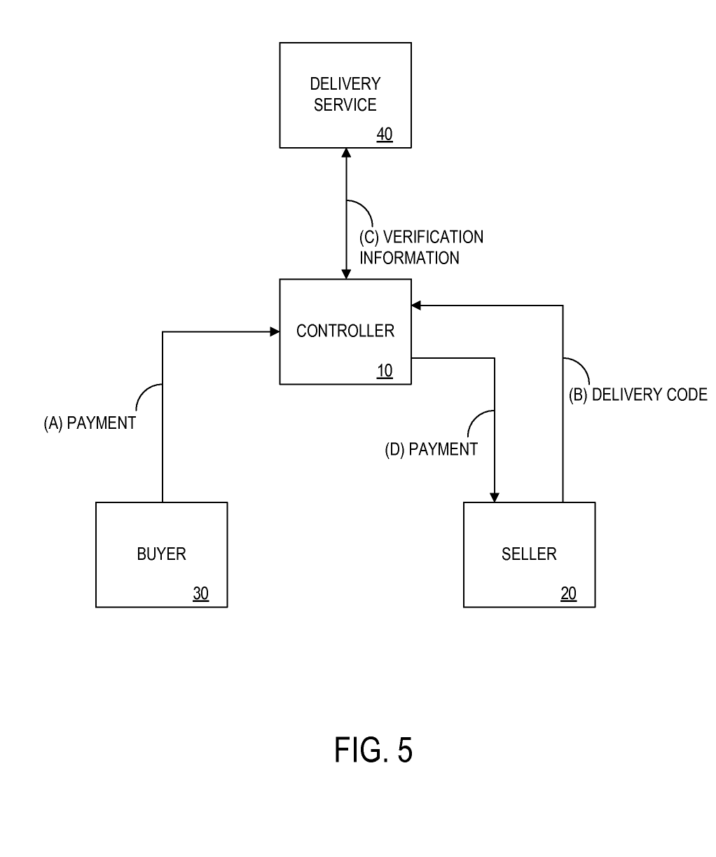

FIG. 5 is a flow diagram of a transaction performed according to another embodiment of the present invention. In this case, a seller 20 provides an item to a buyer 30 via a delivery service 40. The controller 10 receives payment from the buyer 30 at (A) and receives a delivery code from the seller 20 at (B). The delivery code may comprise, for example, a U.S. Post Office, FEDERAL EXPRESS®, or UNITED PARCEL SERVICE® shipping and/or tracking number. According to another embodiment, the controller 10 may receive a delivery code directly from the delivery service 40. In this case, there may be no need for the controller 10 to verify the delivery code.

The controller 10 exchanges verification information with the appropriate delivery service 40 at (C). For example, the controller 10 may transmit the delivery code received from the seller 20 to the delivery service 40. The delivery service 40 may then verify that the seller 20 did in fact ship an item on a particular date. After verifying the delivery code, the controller 10 arranges for the seller 20 to receive payment in exchange for the item at (D).

Note that the features of the transaction described above with respect to FIGS. 1, 3, and 5 may be combined. For example, the controller 10 may provide a first transfer code to the seller 20 and a second transfer code to the buyer 30. In this case, the seller 20 and the buyer 30 may exchange transfer codes when they meet.

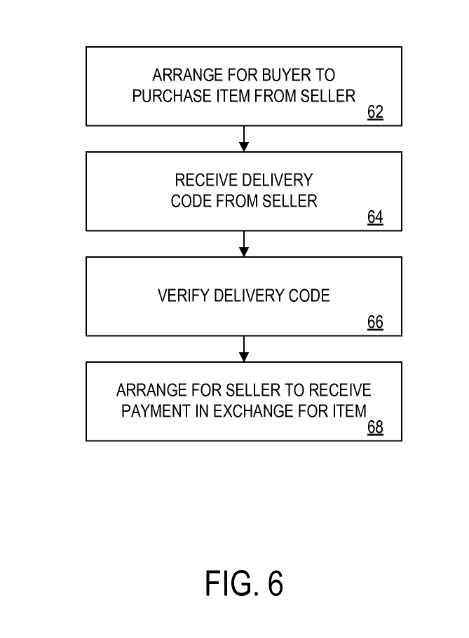

FIG. 6 is a flow chart of a transaction method that may be performed by the controller 10 of FIG. 5. Note that various embodiments of the present invention described with respect to FIG. 2 are also applicable to the method illustrated in FIG. 6. At 62, the controller arranges for the buyer 30 to purchase the item from the seller 20. A delivery code is received from the seller 20 at 64, and the controller 10 verifies the received delivery code at 66. After the delivery code is verified, the controller 10 arranges for the seller 20 to receive payment in exchange for providing the item to the buyer 30.

In the above embodiments, the controller 10 may have arranged for the sale of the item. According to other embodiments, however, another party may arrange for the seller 20 to sell the item to the buyer 30. In this case, the controller 10 may receive information about the transaction and generate a transfer code for the seller 20 and/or the buyer 30.

Transaction System Architecture

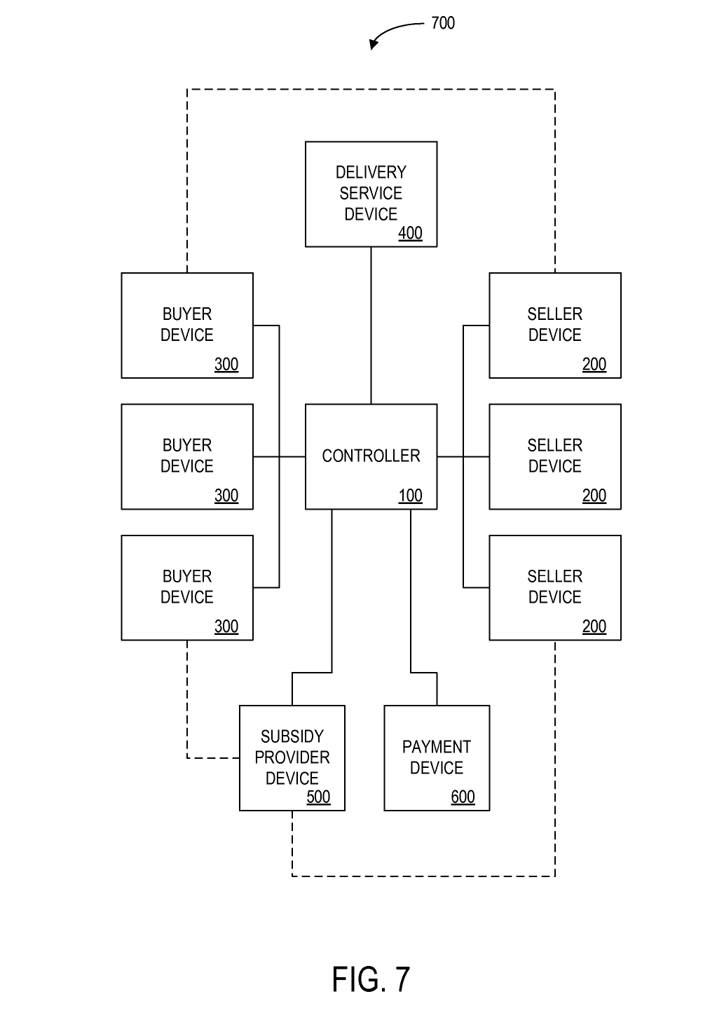

FIG. 7 is a block diagram overview of a transaction system 700 according to one embodiment of the present invention. The transaction system 700 includes seller devices 200 and buyer devices 300 in communication with a controller 100. As used herein, devices (such as the seller devices 200, the buyer devices 300, and/or the controller 100) may communicate, for example, via a communication network, such as a Local Area Network (LAN), a Metropolitan Area Network (MAN), a Wide Area Network (WAN), a Public Switched Telephone Network (PSTN), or an Internet Protocol (IP) network such as the Internet, an intranet or an extranet. Moreover, as used herein, communications include those enabled by wired and/or wireless technology.

Note that the seller devices 200 and the buyer devices 300 may not be in constant communication with the controller 100. For example, a seller device 200 might only communicate with the controller 100 when a seller accesses a Web site associated with the controller 100. Although embodiments of the present invention are described with respect to information exchanged via a Web site, according to other embodiments information can instead be exchanged via, for example: a telephone, an IVRU, a facsimile machine, postal mail, an e-mail message, a WEBTV® interface, an ATM device, a cable network interface, and/or a wireless communication system.

In general, the controller 100 may be any device capable of performing methods in accordance with the present invention. For example, the controller 100 may be a Web server. The seller device 200 and/or the buyer device 300 may be, for example: a PC, a portable computing device such as a PDA, a wired or wireless telephone, a one-way or two-way pager, a kiosk, an ATM device, a smart card, a magnetic stripe card, or any other appropriate communication or storage device.

Note that the seller devices 200 and/or the buyer devices 300 may include a number of different types of devices (e.g., some buyers may use PCs while others use telephones). Also note that any of the seller devices 200, the buyer devices 300, and/or the controller 100 may be incorporated in a single device (e.g., a kiosk network may serve as a seller device 200, a buyer device 300, and a controller 200).

The delivery service device 400 may be, for example, a remote device associated with a delivery service, such as FEDERAL EXPRESS® or UNITED PARCEL SERVICE®. The payment device 600 may be, for example, a remote device associated with a credit card service, a debit card service, a banking service, or a digital payment protocol.

According to an embodiment of the present invention, the controller 100 may receive an offer, including offer information, from a seller device 200 or a buyer device 20. As used herein, an “offer” may mean either an OTB or an OTS and is not limited to the legal definition of an offer (i.e., an offer may include a communication that will not result in a binding contract when accepted). Typically, the offer information associated with an OTB is “broad” (e.g., only an item category is provided) and the offer information associated with an OTS is “specific” (e.g., a seller describes in detail a particular item he or she is interested in selling).

According to one embodiment, the controller 100 stores indications of “quality classes” which indicate various levels of item quality. For example, the controller 100 may use the offer information to assign a quality score (e.g., a score indicating that the item has four out of five desirable features) and, based on the quality score, assign the offer to a particular quality class. The quality class may, for example, enable the controller 100 to find a matching offer with a comparable quality. Determining a quality class may also enable the controller 100 to determine and suggest an appropriate item price (e.g., $50) or item price range (e.g., $45 to $55) for an offer.

The controller 100 may match an OTS and an OTB, for example, when a new OTS is received, when a new OTB is received, and/or on a periodic (e.g., every hour) or non-periodic basis. The controller 100 may then, according to one embodiment, retrieve the item price associated with each potentially matching offer. When searching for a match for an OTS, the controller 100 may eliminate a potentially matching OTB if an item price associated with the OTB (e.g., a maximum buyer price) is lower than an item price associated with the OTS (e.g., a minimum seller price). Similarly, when searching for a match for an OTB, the controller 100 may eliminate a potentially matching OTS if an item price associated with the OTS is higher than an item buyer price associated with the OTB.

If the controller 100 determines that a matching offer cannot be found, the controller 100 may, according to one embodiment, calculate a subsidy amount that would need to be added to (or subtracted from) an offer price in order to find at least one matching offer. For example, consider an OTS associated with a seller price of $100. The controller 100 may determine that a first OTB associated with a buyer price of $50 and a second OTB associated with a buyer price of $80 potentially match the OTS (e.g., each OTB is associated with an item category that matches the item associated with the OTS). In this case, the controller 100 may determine that a subsidy of $20 (i.e., $100−$80) would enable the second OTB to match the OTS. Note that the $20 may either be added to the OTB or subtracted from the OTS. When the subsidy is provided by a third party (e.g., a party other than the controller 100, the buyer and/or the seller), the controller 100 may communicate with a subsidy provider device 500 to determine if the subsidy may be offered to the buyer or the seller (e.g., in exchange for the buyer and/or the seller performing a task).

Note that a seller device 200 and/or a buyer device 300 may also communicate directly with each other and/or with the subsidy provider device 500 (as shown by dashed lines in FIG. 7). For example, a subsidy provider may offer to contribute an amount that will enable an OTS to match with an OTB if both the seller and the buyer apply for a new credit card. In this case, the credit card application information (e.g., the customer's name, address and Social Security number) may be transmitted directly from the seller device 200 and the buyer device 300 to the subsidy provider device 500. Similarly, information about available subsidy offers may be transmitted directly from the subsidy provider device 500 to one or more seller devices 200 and/or buyer devices 300.

Note that although a single subsidy provider device 500 is shown in FIG. 7, any number of subsidy provider devices 30 may be included in the transaction system 100. Similarly, any number of the other devices described herein may be included according to embodiments of the present invention (e.g., a number of controllers may operate together).

Transaction Examples

Several transaction examples will now be described to illustrate how the transaction system 700 may be used according to various embodiments of the present invention. Although some examples are described with respect to an OTB submitted by a buyer, it will be understood by those skilled in the art that similar examples may involve an OTS submitted by a seller.

Consider a buyer who is interested in purchasing an item. The controller 100 may receive buyer offer information, such as buyer registration information (e.g., submitted when the buyer registered to use the controller 100) and/or an OTB, from a buyer device 300.

The controller 100 may receive the buyer offer information, for example, after leading the buyer through a series of questions (e.g., pull-down menus displayed via a Web site) to define an item category (e.g., exercise equipment) and a condition of the item (e.g., “good,” “fair,” or “poor”).

The controller 100 may instead prompt the buyer to enter a general description of the item he or she is interested in purchasing. For example, the buyer may supply a brand name, a manufacturer, and model number of a particular item her or she is interested in purchasing (or of a representative item). In this case, the controller 100 may categorize the description for the buyer.

In general, the buyer offer information will be broad, such as an item category or a general description of the desired item, such as a list of acceptable brands. For example, the buyer offer information may include one or more product features or accessories that must be included with item.

With respect to an OTS, the seller offer information will typically be more specific. For example, the seller offer information may indicate the manufacturer, model number, condition, year, and color of an item. That is, the seller is describing a particular item that is being offered for sale. For example, the seller offer information may indicate that the seller is interested in selling a “1993 SONY® WALKMAN®, working condition.”

In addition to information about a type of item or a particular item, offer information may include information about the buyer and/or the seller. For example, offer information may include a name, an address, contact information (e.g., an e-mail address or a telephone number) and/or demographic information. The offer information may also include a payment identifier (e.g., a credit card number) that may be used by the controller 100 to collect transaction fees from buyers and/or sellers via the payment device 600. The payment identifier may also be used to credit or debit an account as appropriate to complete a transaction (e.g., an amount based on an item price). According to one embodiment, such payments may be made over time in installments.

The offer information may also include an offer price. That is, an OTS may include a seller price. The seller price may represent, for example, a seller asking price (e.g., an amount the seller would like to receive) and/or a seller minimum price (e.g., an amount below which the seller would not sell an item). Similarly, an OTB may include a buyer price (e.g., a buyer asking price and/or a buyer maximum price).

The offer information may also include a time limit, such as an offer period or expiration date. Such a time limit may be used, for example, by the controller 100 to reduce the chance that an OTS or an OTB will remain unmatched for an unreasonable amount of time (e.g., when more than one potentially matching OTB is determined, the controller 100 may select the OTB with the nearest expiration date).

The offer information may also include delivery information, such as a shipping preference. For example, a buyer may choose to pick up an item at a specific place or have the item shipped to his or her home. In one embodiment, the controller 100 displays a map which a buyer (or a seller) can use to specify how far he or she is willing to travel to pick up (or deliver) an item.

During a transaction, the controller 100 may provide a subsidy offer to a buyer (and/or a seller). For example, a subsidy offer may be provided to a buyer when he or she initially registers with the controller 100, when the buyer submits an OTB, when no potentially matching OTS is located, or prior to an expiration date associated with the OTB. For example, the buyer may receive a message stating “Sign up for AT&T® long distance service, and we'll advance you in our matching queue—you'll get a better product in less time!” Several types of subsidy offers are described in U.S. patent application Ser. No. 09/274,281 entitled “Method and Apparatus for Providing Cross-Benefits via a Central Authority.” The buyer's response to the subsidy offer (e.g., an acceptance) may be received and stored by the controller 100.

According to one embodiment, a seller's OTS and/or a buyer's OTB is a “binding” offer. That is, a penalty may be applied if the seller and/or the buyer do not complete a transaction. For example, the controller 100 may notify a buyer of a penalty (e.g., a predetermined or variable penalty amount). A penalty may be applied, for example, if the buyer fails to pick up an item. The controller 100 may similarly notify a seller of a penalty imposed, for example, if he or she misrepresents the quality of an item sold to a buyer.

When an OTS is matched with an appropriate OTB, the controller 100 arranges for the buyer to purchase the item from the seller. For example, the controller 100 may receive payment from the buyer (e.g., via the payment device 600) and transmit a transfer code to the buyer device 300. For example, the controller 100 may transmit the transfer code to the buyer's PC, and the buyer may then use a printer coupled to the PC to generate a voucher that indicates the transfer code. The controller 100 may also arrange for the buyer and the seller to meet at a mutually convenient location.

When the buyer and the seller meet, the seller provides the item to the buyer. If the buyer finds the item acceptable, he or she provides the transfer code to the seller (e.g., by handing a voucher indicating the transfer code to the seller). The seller returns home and uses his or her seller device 200 to transmit the transfer code to the controller 100. The controller 100 verifies the transfer code and arranges for the seller to receive payment in exchange for providing the item to the buyer (e.g., via the payment device 600).

As another example, consider Sally who submits an OTS form via a Web site associated with the controller 100. On the form, she indicates that she is looking to sell a microwave for at least $50. She also enters her credit card number. Sally further indicates that she is willing to drive at most ten miles to drop the microwave off; and that she is only willing to reveal her e-mail address to a buyer. Finally, Sally indicates that she wishes to have a check sent to her home address as payment for the microwave.

Bob fills out an OTB form on the Web site. Bob indicates a desire to buy a microwave for at most $50 and enters his credit card number. Bob further indicates that he would like to have the microwave dropped off at his house, and that he is willing to reveal his e-mail address, phone number, and home address to a seller.

The controller 100 determines that Sally's OTS and Bob's OTB are a suitable match because:
Sally is selling the product Bob wants to buy at the price Bob wants to pay.
Bob lives only five miles away from Sally. Therefore, Sally's willingness to drive up to ten miles to drop the microwave off matches with Bob's preference of having the microwave dropped off at his home.

The controller matches or binds Sally's OTS and Bob's OTB and charges $52 to Bob's credit card, including $50 for the microwave and a $2 commission. The controller also generates a four-digit transfer code “2467” associated with the transaction.

Because Bob was willing to release his e-mail address, shipping address, and telephone number to a seller, the controller sends an e-mail message to Sally containing:
Bob's e-mail message address, shipping address, and telephone number.
Instructions to contact Bob to set up a time for Sally to deliver the microwave to Bob's home.
Instructions to get the transfer code from Bob when the microwave is delivered, and to enter the transfer code into the Web site in order to confirm the sale.

Because Sally was willing to release her e-mail address, the controller 100 sends an e-mail message to Bob containing:
An indication that Bob's credit card has been charged $50 for the purchase of a microwave and an additional $2 for as a commission.
The transfer code of “2467.”
Sally's e-mail address, with instructions for Bob to contact Sally if he doesn't hear from her within three days.
An indication that the controller 100 will contact Bob in four days to make sure he received the microwave and that it is in good working condition.

A day after receiving her e-mail message from the controller 100, Sally sends an e-mail message to Bob. She asks Bob whether he would be available the following evening after 6:00 PM to receive the microwave. Bob replies to Sally that he is available and that she can deliver the microwave at 7:30 PM. The following day, the controller 100 sends a status e-mail message to both Sally and Bob. Sally's e-mail message indicates that Sally's microwave transaction is still not complete, and that the controller 100 awaits a transfer code from Sally. Bob's e-mail message indicates that Bob's microwave transaction is still not complete, and that the controller 100 awaits an indication of Bob's satisfaction with the microwave.

That evening at 7:30 PM Sally drives the microwave to Bob's house and hands the microwave to Bob. Bob plugs in the microwave, and sees that the microwave works. He gives Sally a piece of paper with “2467” written on it.

Sally goes home, logs onto the Web site and links to a form containing her “active transactions.” In the appropriate transfer code field (e.g., when Sally has a number of active transactions), Sally enters in “2467.” The controller 100 verifies that the transfer code is valid and assumes that Sally has given the microwave to Bob and that Bob is satisfied with it. The controller therefore sends a $48 check to Sally's home address. However, the controller 100 also freezes $48 via Sally's credit card account (e.g., Sally's credit limit is effectively lowered by $48).

The controller 100 sends an e-mail message to Sally. The e-mail message contains:
An indication that Sally has sold her microwave to Bob, and that the current e-mail message will act as a receipt.
An indication that the controller 100 has sent Sally a $48 check, representing $50 for the microwave less a $2 commission.
An indication that the controller 100 has frozen $48 via Sally's credit card account, and that the funds will remain frozen for 12 days or until the buyer expresses satisfaction with the microwave.

The controller also sends an e-mail message to Bob. The e-mail message contains:
An indication that the transfer code was received
Instructions to log onto the Web site and express satisfaction with the microwave.

Bob, however, does not log onto the Web site. The controller 100 sends another e-mail message to Bob asking whether he is satisfied with the microwave. Bob responds that he is satisfied. At this point, the controller 100 releases the $48 of Sally's credit and sends an e-mail message to Sally informing her that her credit has been released.

Controller

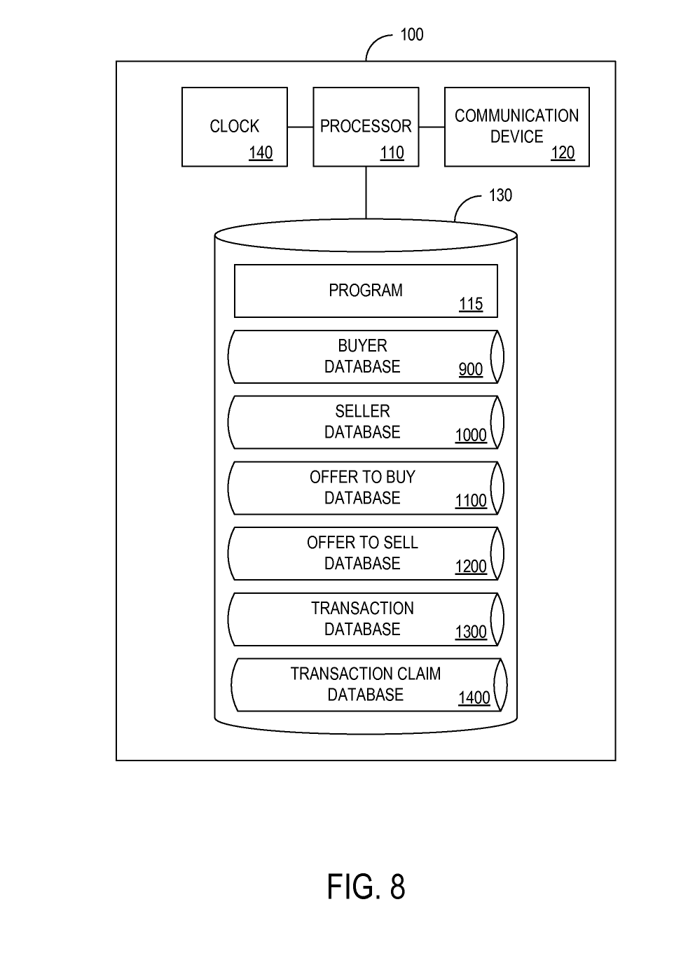

FIG. 8 illustrates a controller 100 that is descriptive of the device shown in FIG. 7 according to an embodiment of the present invention. The controller 100 comprises a processor 110, such as one or more INTEL® Pentium® processors, in communication with a communication device 120 configured to communicate through a communication network (not shown in FIG. 8). The communication device 120 may be used to communicate, for example, with one or more seller devices 200, buyer devices 300, delivery service devices 400, subsidy provider devices 500, and/or payment devices 600. A clock 140 in communication with the processor 110 may generate, for example, current date and time information.

The processor 110 is also in communication with a storage device 130. The storage device 130 may comprise any appropriate information storage device, including combinations of magnetic storage devices (e.g., magnetic tape and hard disk drives), optical storage devices and semiconductor memory devices, such as Random Access Memory (RAM) devices and Read Only Memory (ROM) devices.

The storage device 130 stores a program 115 for controlling the processor 110. The processor 110 performs instructions of the program 115, and thereby operates in accordance with the present invention. For example, the processor 110 may transmit a transfer code to the buyer, receive the transfer code from the seller as an indication that the buyer has received the item, and arrange for the seller to receive payment in exchange for providing the item to the buyer.

According to another embodiment, the processor 110 may arrange for the buyer to purchase the item from the seller, transmit a transfer code to the seller, and receive the transfer code from the buyer.

According to another embodiment, the processor 110 may arrange for the buyer to purchase the item from the seller, receive a delivery code from the seller, and arrange for the seller to receive payment in exchange for providing the item to the buyer.

According to another embodiment, the processor 110 may receive information associated with the transaction, transmit a transfer code to the buyer after the buyer has provided payment for the item, receive the transfer code from the seller as an indication that the buyer has received the item, and arrange for the seller to receive payment in exchange for providing the item to the buyer.

According to another embodiment, the processor 110 may receive an indication of a first preferred method of delivery from the seller and an indication of a second preferred method of delivery from the buyer. Based on the first preferred method of delivery and the second preferred method of delivery, the processor 110 may arrange for the buyer to purchase the item from the seller.

According to another embodiment, the processor 110 may arrange for the buyer to purchase the item from the seller, receive complaint information from the buyer and/or the seller, and, based on the received complaint information, apply a penalty to the buyer and/or the seller.

The program 115 may be stored in a compressed, uncompiled or encrypted format. The program 115 may furthermore include program elements such as an operating system, a database management system, and/or “device drivers” used by the processor 110 to interface with peripheral devices.

Note that the processor 110 and the storage device 130 may be, for example: (i) located entirely within a single computer or other computing device or (ii) located in separate devices coupled through a communication channel. In one embodiment, the controller 100 comprises one or more computers that are connected to a remote database server.

As used herein, information may be “received” by, for example: (i) the controller 100 from any other device or (ii) a software application or module within the controller 100 from another software application, module or any other source. Similarly, information may be “transmitted” to, for example: (i) another device from the controller 100 or (ii) a software application or module within the controller 100 from another software application, module or any other source.

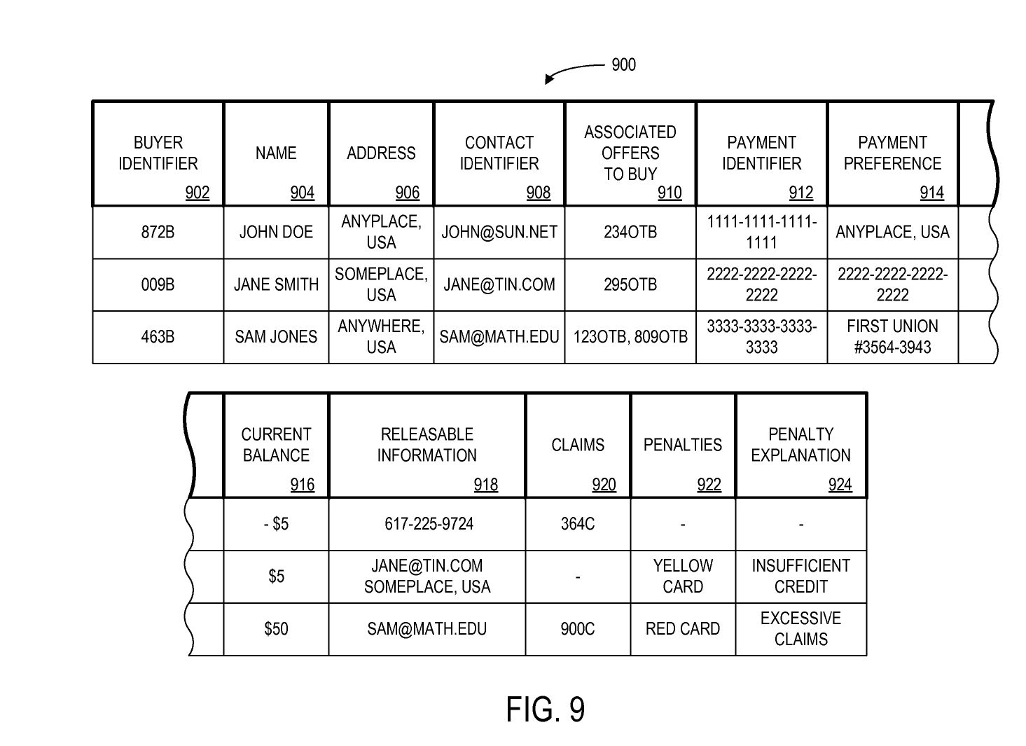

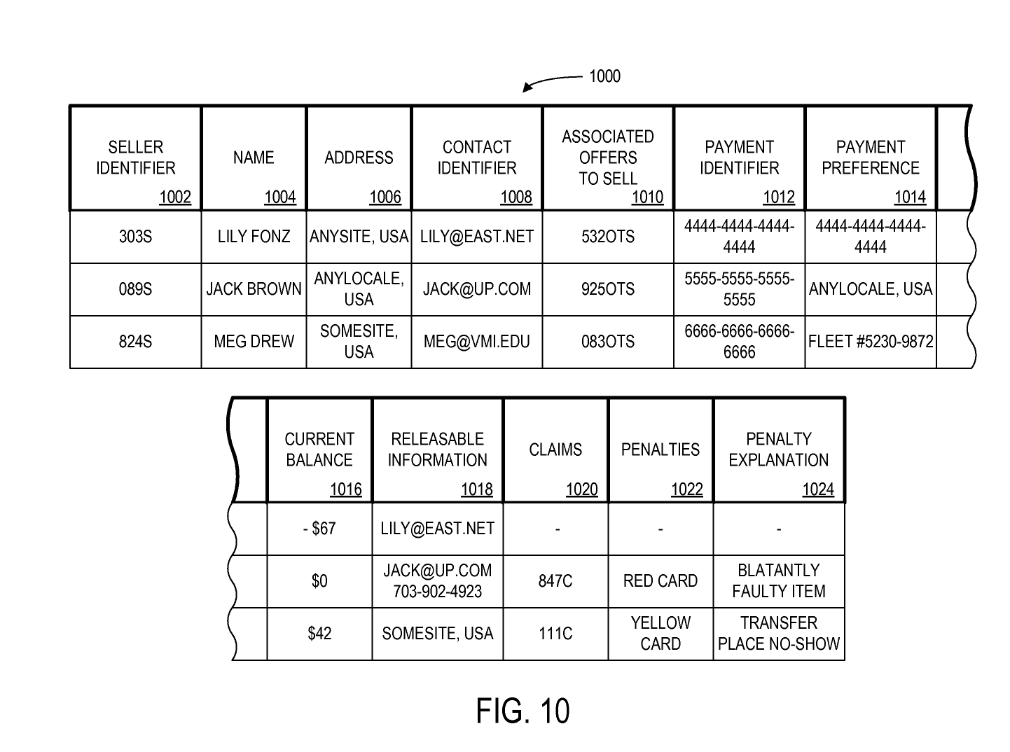

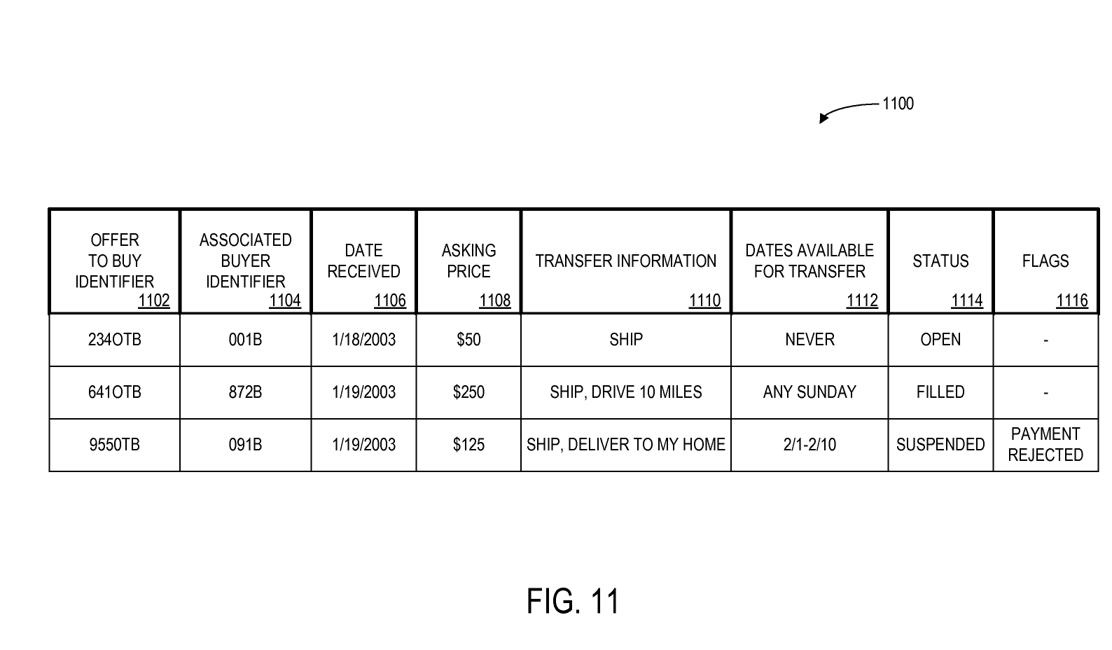

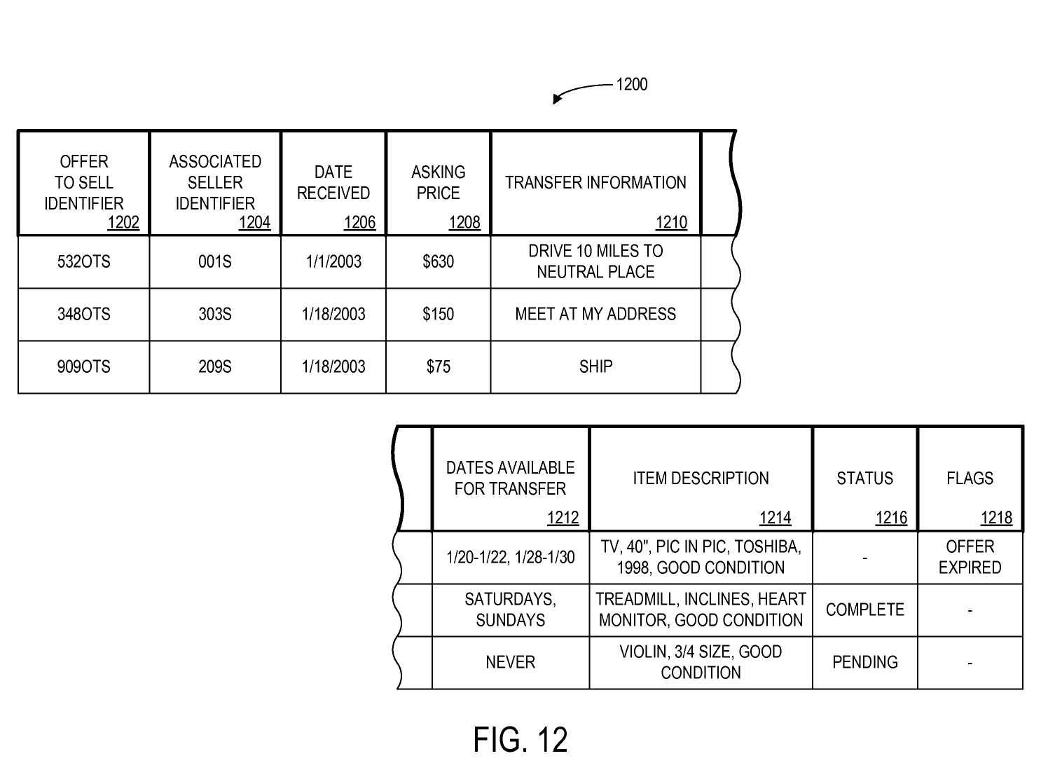

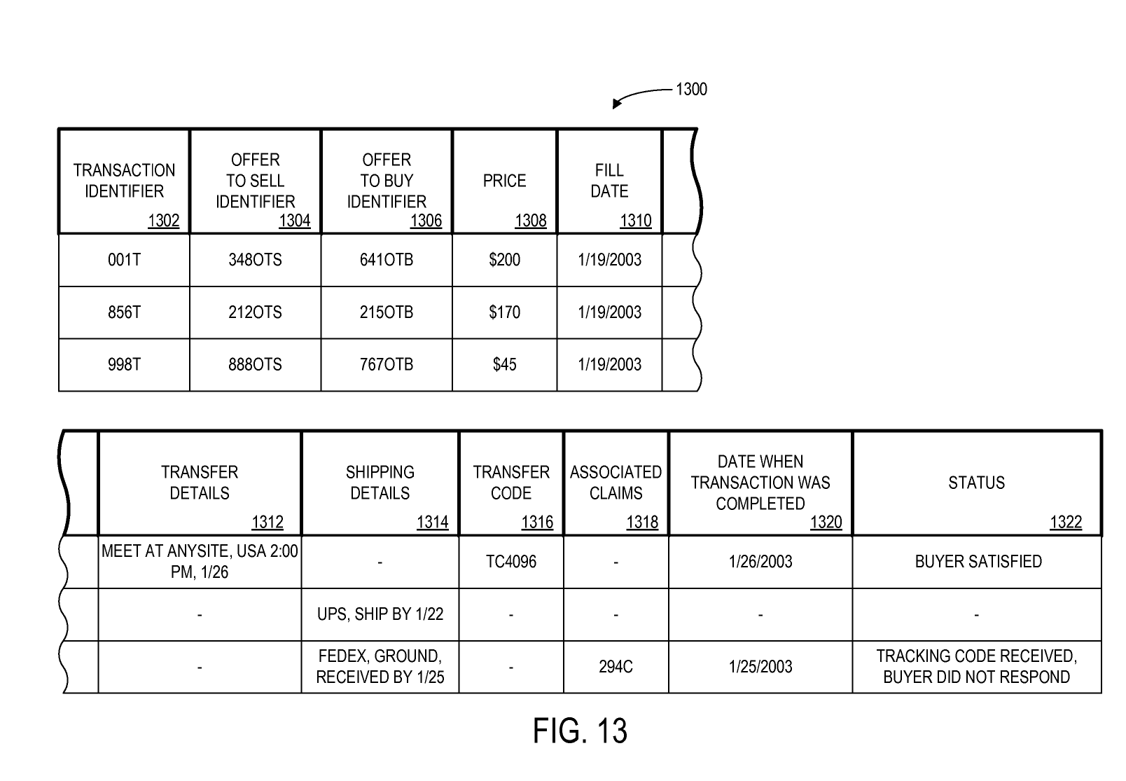

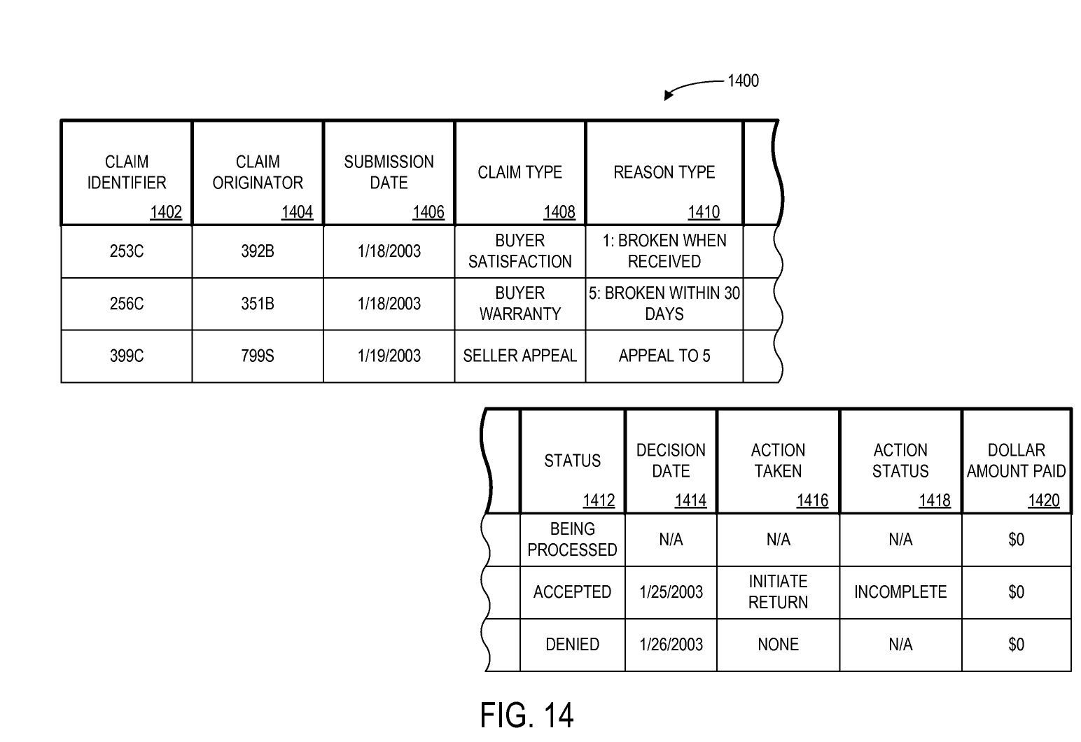

As shown in FIG. 8, the storage device 130 also stores: a buyer database 900 (described with respect to FIG. 9); a seller database 1000 (described with respect to FIG. 10); an offer to buy database 1100 (described with respect to FIG. 11); an offer to sell database 1200 (described with respect to FIG. 12); a transaction database 1300 (described with respect to FIG. 13); and a transaction claim database 1400 (described with respect to FIG. 14).

Examples of databases that may be used in connection with the transaction system 700 will now be described in detail with respect to FIGS. 9 through 14. Each figure depicts a database in which the data is organized according to a data structure in accordance with embodiments of the present invention. The data may be stored, for example, on a computer readable medium and be accessible by a program executed on a data processing system. The schematic illustration and accompanying description of these databases are exemplary, and any number of other database arrangements could be employed besides those suggested by the figures.

Buyer Database

Referring to FIG. 9, a table represents one embodiment of the buyer database 900 that may be stored at the controller 100 according to an embodiment of the present invention. The table includes entries identifying buyers who may offer to make a purchase. The table also defines fields 902, 904, 906, 908, 910, 912, 914, 916, 918, 920, 922, 924 for each of the entries. The fields specify: a buyer identifier 902; a name 904; an address 906; a contact identifier 908; associated offers to buy 910; a payment identifier 912; a payment preference 914; a current balance 916; releasable information 918; claims 920; penalties 922; and a penalty explanation 924. The information in the buyer database 900 may be created and updated, for example, when a buyer registers with the controller 100 and/or during a transaction.

The buyer identifier 902 may be, for example, an alphanumeric code associated with a buyer who may offer to make a purchase via the transaction system 700. The buyer identifier 902 may be, for example, generated by the controller 100 or the buyer (e.g., when the buyer selects a user name and password).

For each buyer, the buyer database 900 may also store the name 904 and the address 906 associated with the buyer. This information may be based on, for example, information provided by the buyer when he or she registers with the controller 100.

For each buyer, the buyer database 900 may also store the contact identifier 908 that the controller 100 can use to contact the buyer (e.g., to provide a transfer code to the buyer or to inform the buyer that an OTB has been matched). The contact identifier 908 may be, for example, an e-mail address or a telephone number and may be based on, for example, information provided by the buyer when he or she registers with the controller 100 or submits an OTB.

The buyer database 900 may also store an indication (e.g., an identifier) of the associated offers to buy 910 that have been submitted by the buyer. For example, as illustrated by the third entry of FIG. 9, the buyer having a buyer identifier of “463B” has submitted two offers to buy (i.e., “123OTB” and “809OTB”).

The payment identifier 912 and the payment preference 914 stored in the buyer database 900 may be used by the controller 100, for example, to arrange for the buyer to pay for an item, to charge the buyer a fee in exchange for facilitating a transaction, and/or to apply a penalty to the buyer. Note that the payment preference 914 associated with a buyer may be different that the payment identifier 912 associated with the buyer. For example, a buyer may prefer to pay for items by being billed at his or her home address. In this case, the payment identifier 912 (e.g., a credit card number) may be used by the controller 100 only if the buyer fails to pay a bill within a predetermined period of time.

The current balance 916 stored in the buyer database 900 may indicate, for example, fees, item prices and/or penalty amounts that the buyer owes to (or is due from) the controller 100 and/or to one or more sellers.

The buyer database 900 may also store the releasable information 918 associated with the buyer. For example, a buyer may indicate that his or her e-mail address and/or telephone number can be released (e.g., to a potential seller) during a transaction.

The buyer database 900 may also store claims 920 identifying complaints about an item or transaction that have been received from the buyer and/or the seller. According to another embodiment, the claims 920 may also be generated by the controller 100, a delivery service device 400, and/or a subsidy provider device 500.

The buyer database 900 may also store one or more penalties 922 that have been applied to the buyer (e.g., a “yellow card” indicating a moderate penalty and a “red card” indicating a more serious penalty) along with a penalty explanation 924. For example, a buyer may prohibited from initiating further transactions for one month because he or she failed to appear at a meeting arranged with a seller.

Seller Database

Referring to FIG. 10, a table represents one embodiment of the seller database 1000 that may be stored at the controller 100 according to an embodiment of the present invention. The table includes entries identifying sellers who may offer to sell an item. The table also defines fields 1002, 1004, 1006, 1008, 1010, 1012, 1014, 1016, 1018, 1020, 1022, 1024 for each of the entries. The fields specify: a seller identifier 1002; a name 1004; an address 1006; a contact identifier 1008; associated offers to sell 1010; a payment identifier 1012; a payment preference 1014; a current balance 1016; releasable information 1018; claims 1020; penalties 1022; and a penalty explanation 1024. The information in the seller database 1000 may be created and updated, for example, when a seller registers with the controller 100 and/or during a transaction.

The seller identifier 1002 may be, for example, an alphanumeric code associated with a seller who may offer to sell an item via the transaction system 700. The seller identifier 1002 may be, for example, generated by the controller 100 or the seller (e.g., when the seller selects a user name and password).

For each seller, the seller database 1000 may also store the name 1004 and the address 1006 associated with the seller. This information may be based on, for example, information provided by the seller when he or she registers with the controller 100.

For each seller, the seller database 1000 may also store the contact identifier 1008 that the controller 100 can use to contact the seller (e.g., to provide a transfer code to the seller or to inform the seller that an OTS has been matched). The contact identifier 1008 may be, for example, an e-mail address or a telephone number and may be based on, for example, information provided by the seller when he or she registers with the controller 100 or submits an OTS.

The seller database 1000 may also store an indication (e.g., an identifier) of the associated offers to sell 1010 that have been submitted by the seller. For example, as illustrated by the first entry of FIG. 10, the seller having a seller identifier of “303S” has submitted one offer to sell (i.e., “532OTS”).

The payment identifier 1012 and the payment preference 1014 stored in the seller database 1000 may be used by the controller 100, for example, to arrange for the seller to receive payment for an item, to charge the seller a fee in exchange for facilitating a transaction, and/or to apply a penalty to the seller.

The current balance 1016 stored in the seller database 1000 may indicate, for example, fees, item prices and/or penalty amounts that the seller owes to (or is due from) the controller 100 and/or to one or more buyers.

The seller database 1000 may also store the releasable information 1018 associated with the seller. For example, a seller may indicate that his or her e-mail address and/or telephone number may be released (e.g., to a potential buyer) during a transaction.

The seller database 1000 may also store claims 1020 identifying complaints about an item or transaction that have been received from the seller and/or a buyer. According to another embodiment, the claims 1020 may also be generated by the controller 100, a delivery service device 400, and/or a subsidy provider device 500.

The seller database 1000 may also store one or more penalties 1022 that have been applied to the seller along with a penalty explanation 1024. For example, a seller may be charged a $10 fee because he or she has attempted to sell an item that did not work properly.

Note that the buyer database 900 and the seller database 1000 may comprise a single database. In this case, the database may store both OTS and OTB information regarding each party.

Offer to Buy Database

Referring to FIG. 11, a table represents one embodiment of the offer to buy database 1100 that may be stored at the controller 100 according to an embodiment of the present invention. The table includes entries identifying offers to purchase items. The table also defines fields 1102, 1104, 1106, 1108, 1110, 1112, 1114, 1116 for each of the entries. The fields specify: an offer to buy identifier 1102; an associated buyer identifier 1104; a date received 1106; an asking price 1108; transfer information 1110; dates available for transfer 1112; a status 1114; and one or more flags 1116. The information in the offer to buy database 1100 may be created and updated, for example, when an OTB is received from a buyer.

The offer to buy identifier 1102 may be, for example, an alphanumeric code associated with a buyer's offer to purchase an item. The offer to buy identifier 1102 may be, for example, generated by the controller when a buyer submits an OTB and may be used to indicate the associated offers to buy 910 stored in the buyer database 900. The associated buyer identifier 1104 indicates the buyer who submitted the offer, and may be based on the buyer identifier 902 stored in the buyer database 900. The date received 1106 may indicate the date (and time of day) that the OTB was received by the controller 100.

The asking price 1108 may represent an amount the buyer would like to (or is willing to) pay for an item. The asking price 1108 may be, for example, selected by the buyer (e.g., when the buyer selects one of a number of prices determined by the controller 100) or be determined by the controller 100 based on information received from the buyer (e.g., based on an item category).

The transfer information 1110 and the dates available for transfer 1112 may indicate how and when the buyer is willing to receive an item. For example, a buyer may be willing to travel a predetermined distance on particular days (e.g., he or she may be willing to travel five miles on weekends) to receive an item.

The status 1114 represents the status of the OTB. For example, when the OTB is initially received it may be assigned a status 1114 of “open.” When the OTB is being evaluated as a possible match for an OTS, it may be assigned a status 1114 of “pending.” When the OTB is matched with an OTS, it may be assigned a status 1114 of “filled.” When the buyer has purchased and received the item from a seller, the OTB may be assigned a status 1114 of “complete.” According to one embodiment, OTB may be assigned a status 1114 of “suspended” when, for example, the buyer's credit card has been rejected or the buyer has engaged in misconduct. The flags 1116 may indicate, for example, if a particular offer to buy has expired (e.g., when an offer is only valid for a predetermined period of time).

Note that the offer to buy database 1100 may also store a description of the type of item the buyer is interested in purchasing (e.g., a 32 inch screen television made by a particular manufacturer). According to another embodiment, the controller 100 may use different offer to buy databases for each type of item that may be purchased via the transaction system 700.

Offer to Sell Database

Referring to FIG. 12, a table represents one embodiment of the offer to sell database 1200 that may be stored at the controller 100 according to an embodiment of the present invention. The table includes entries identifying offers to sell items. The table also defines fields 1202, 1204, 1206, 1208, 1210, 1212, 1214, 1216, 1218 for each of the entries. The fields specify: an offer to sell identifier 1202; an associated seller identifier 1204; a date received 1206; an asking price 1208; transfer information 1210; dates available for transfer 1212; an item description 1214; a status 1216; and one or more flags 1218. The information in the offer to sell database 1200 may be created and updated, for example, when an OTS is received from a seller.

The offer to sell identifier 1202 may be, for example, an alphanumeric code associated with a seller's offer to sell an item. The offer to sell identifier 1202 may be, for example, generated by the controller when a seller submits an OTS and may be used to indicate the associated offers to sell 1010 stored in the seller database 1000. The associated seller identifier 1204 indicates the seller who submitted the offer, and may be based on the seller identifier 1002 stored in the seller database 1000. The date received 1206 may indicate the date (and time of day) that the OTS was received by the controller 100.

The asking price 1208 may represent an amount the seller would like to (or is willing to) accept for an item. The asking price 1208 may be, for example, selected by the seller (e.g., when the seller selects one of a number of prices determined by the controller 100) or be determined by the controller 100 based on information received from the seller (e.g., based on the item description 1214).

The transfer information 1210 and the dates available for transfer 1212 may indicate how and when the seller is willing to provide an item to a buyer. For example, a seller may only be willing to ship the item to a buyer via a delivery service (e.g., the seller is not interested in providing the item to a buyer in person).

The item description 1214 provides information about the particular item being sold by the seller. For example, the item description 1214 may indicate an item category (e.g., televisions or exercise bicycles), an item manufacturer, one or more features associated with the item (e.g., that a television has a picture-in-picture capability), an item age, and/or an item condition (e.g., “poor” or “fair”).

The status 1216 represents the status of the OTS. For example, when the OTS is initially received it may be assigned a status 1216 of “open.” When the OTS is being evaluated as a possible match for an OTB, it may be assigned a status 1216 of “pending.” When the OTS is matched with an OTB, it may be assigned a status 1216 of “filled.” When the buyer has purchased and received the item from a seller, the OTS may be assigned a status 1216 of “complete.” The flags 1218 may indicate, for example, if a particular offer to sell has expired.

Transaction Database

Referring to FIG. 13, a table represents one embodiment of the transaction database 1300 that may be stored at the controller 100 according to an embodiment of the present invention. The table includes entries identifying transactions that have been filled or completed via the controller 100. The table also defines fields 1302, 1304, 1306, 1308, 1310, 1312, 1314, 1316, 1318, 1320, 1322 for each of the entries. The fields specify: a transaction identifier 1302; an offer to sell identifier 1304; an offer to buy identifier 1306; a price 1308; a fill date 1310; transfer details 1312; shipping details 1314; a transfer code 1316; associated claims 1318; a date when transaction was completed 1320; and a status 1322. The information in the transaction database 1300 may be created and updated, for example, when an OTB and an OTS are matched and/or when the transaction is completed.

The transaction identifier 1302 may be, for example, an alphanumeric code associated with a transaction that has been filled (e.g., matched) or completed via the controller 100. The transaction identifier 1302 may, for example, be generated by the controller 100 when an OTB and an OTS are matched.

For each transaction, the transaction database 1300 stores the offer to sell identifier 1304 and the offer to buy identifier 1306 associated with the OTS and OTB, respectively, that have been matched by the controller 100. The offer to sell identifier 1304 may be based on, or associated with, the offer to sell identifier 1202 stored in the offer to sell database 1200. The offer to buy identifier 1306 may be based on, or associated with, the offer to buy identifier 1102 stored in the offer to buy database 1100.

The price 1308 stored in the transaction database 1300 may indicate an amount the buyer will provide in exchange for an item and/or an amount a seller will receive in exchange for providing the item to the buyer. The fill date 1310 may indicate the date on which an OTS was matched with an OTB.

The transfer details 1312 and the shipping details 1314 contain information associated with the transfer of the item by the seller to the buyer. For example, the seller may meet the buyer at a mutually convenient location to provide the item or may ship the item to the buyer via a delivery service.

The transfer code 1316 may be, according to one embodiment of the present invention, an alphanumeric code that is provided from the controller 100 to the buyer. The controller 100 may also receive the transfer code 1316 from the seller as an indication that the item has been provided to the buyer. The controller 100 may use the stored transfer code 1316, for example, to validate a transfer code received from a seller.

As described with respect to FIG. 14, the associated claims 1318 may indicate, for example, one or more complaints received from the buyer and/or the seller with respect to the transaction.

The date when transaction was completed 1320 may indicate, for example, the date the item was provided to the buyer, the buyer has provided payment of the price 1308, and/or the seller has received payment of the price 1308. The status 1322 indicates the current status of the transaction. For example, the status 1322 may indicate if the buyer is satisfied with the item. The status 1322 may also indicate whether the buyer and/or the seller have performed an action (e.g., provided a transfer code to the controller 100 within a predetermined period of time).

Transaction Claim Database

Referring to FIG. 14, a table represents one embodiment of the transaction claim database 1400 that may be stored at the controller 100 according to an embodiment of the present invention. The table includes entries identifying claims (e.g., complaints) that have been received by the controller 100 from a buyer and/or a seller. The table also defines fields 1402, 1404, 1406, 1408, 1410, 1412, 1414, 1416, 1418, 1420 for each of the entries. The fields specify: a claim identifier 1402; a claim originator 1404; a submission date 1406; a claim type 1408; a reason type 1410; a status 1412; a decision date 1414; an action taken 1416; an action status 1418; and a dollar amount paid 1420. The information in the transaction claim database 1400 may be created and updated, for example, when a claim is received from a buyer and/or a seller or when the controller 100 takes an action in response to a claim.

The claim identifier 1402 may be, for example, an alphanumeric code associated with a claim that has been received by the controller 100. The claim identifier 1402 may, for example, be generated by the controller 100 when a complaint is received from a buyer or a seller.

The claim originator 1404 indicates the party that submitted the claim to the controller 100. The claim originator 1404 may be based on or associated with, for example, the seller identifier 1002 stored in the seller database 1000 or the buyer identifier 902 stored in the buyer database 900. The submission date 1406 indicates the date on which the controller 100 received the claim.

The claim type 1408 and the reason type 1410 describe a general type of complaint and a more detailed explanation of the complaint, respectively. For example, a buyer may submit a claim if he or she received an item that did not work properly.

The status 1412 indicates the status of the claim. For example, a claim may be “accepted” or “denied” by the controller 100. The decision date 1414, the action taken 1416, and the action status 1418 indicate the date on which the controller 100 decided to take an action (or decided not to take an action) in response to the claim, the type of action that being taken (e.g., the controller 100 may “initiate return” of a defective item from the buyer back to the seller), and the status of the action being taken, respectively. In the case where the buyer or seller is to pay an amount as a result of a claim, the dollar amount paid 1420 indicates the amount of money that has been paid by the appropriate party.

Transaction Mapping Information

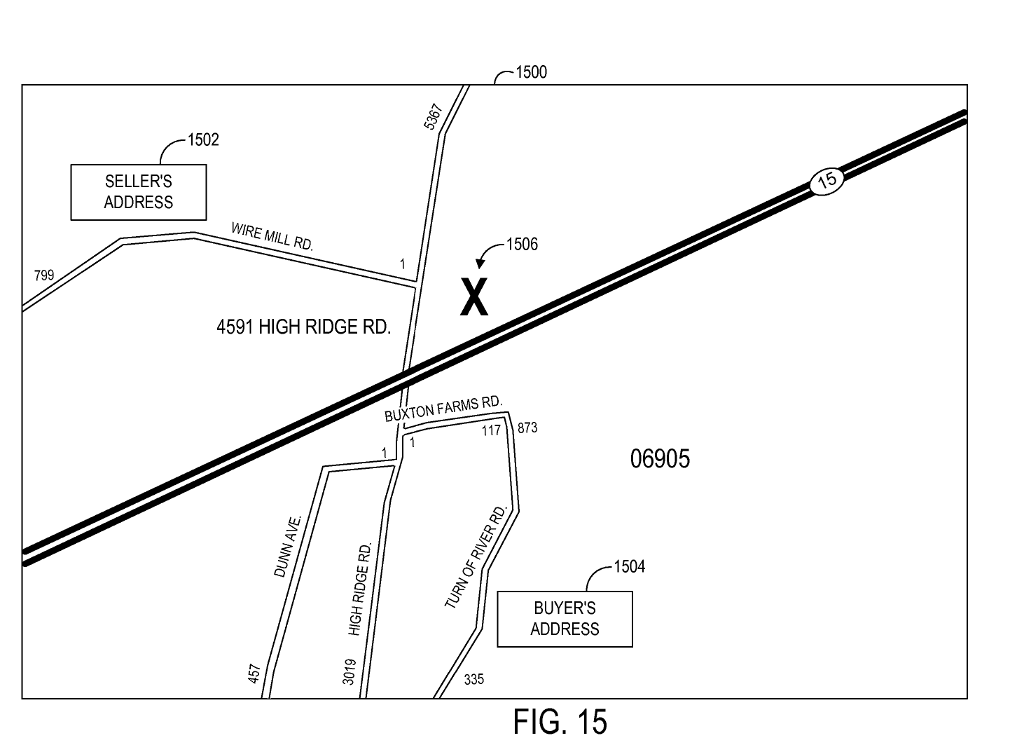

According to some embodiments of the present invention, the controller 100 arranges for the seller to transfer an item to a buyer in person. FIG. 15 is a map illustrating locations at which an item may be transferred according some embodiments of the present invention.

For example, the controller 100 may arrange for the buyer to visit the seller's address 1502 to pick up an item. The controller 100 may instead arrange for the seller to visit the buyer's 1504 to drop off an item. The controller 100 may arrange for the transfer based on, for example, buyer's address 906, the seller's address 1006, the transfer information 1110 and dates available for transfer 1112 associated with an OTB, and the transfer information 1210 and dates available for transfer 1212 associated with an OTS.

According to another embodiment, the controller 100 arranges for the seller and the buyer to meet at a mutually convenient location 1506. For example, the controller 100 may arrange for the buyer and the seller to meet at a nearby fast food restaurant.

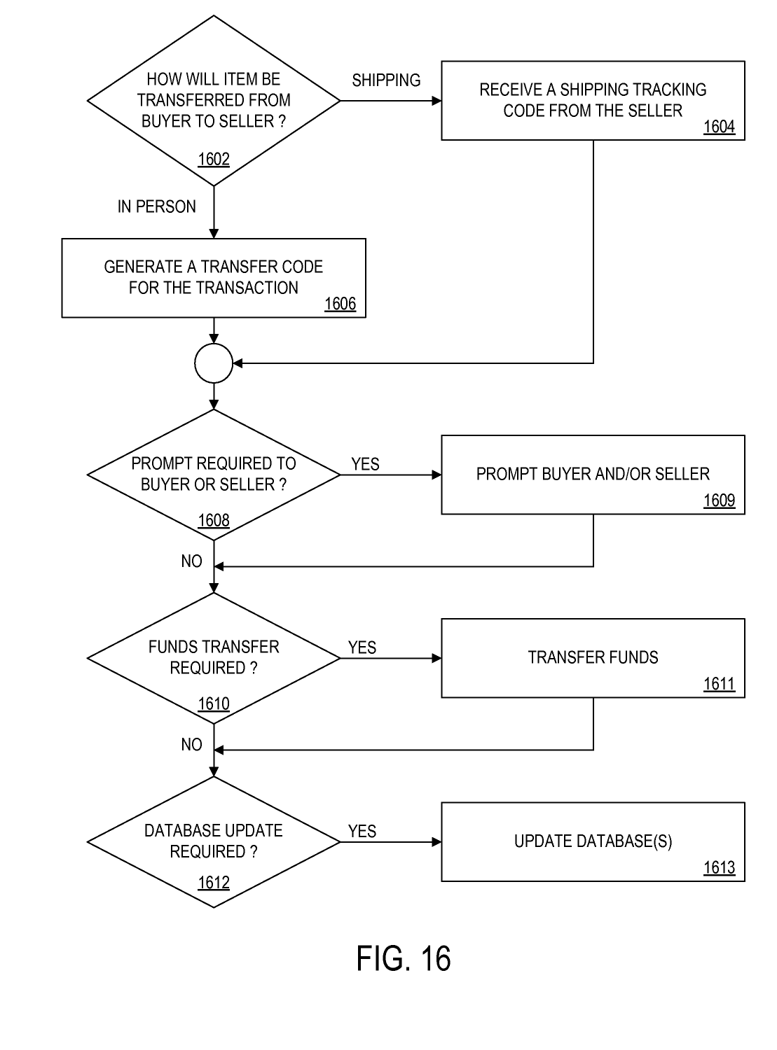

Methods that may be used in connection with the transaction system 700 according to an embodiment of the present invention will now be described in detail with respect to FIGS. 16 through 20.

Transaction System Methods

FIG. 16 is a flow chart illustrating a method which may be performed by a controller 100 according to an embodiment of the present invention. The flow chart depicted in FIG. 16, as well as the other flow charts discussed herein, is not intended to imply a fixed order to the elements shown therein, and embodiments of the present invention can be practiced in any order that is practicable.

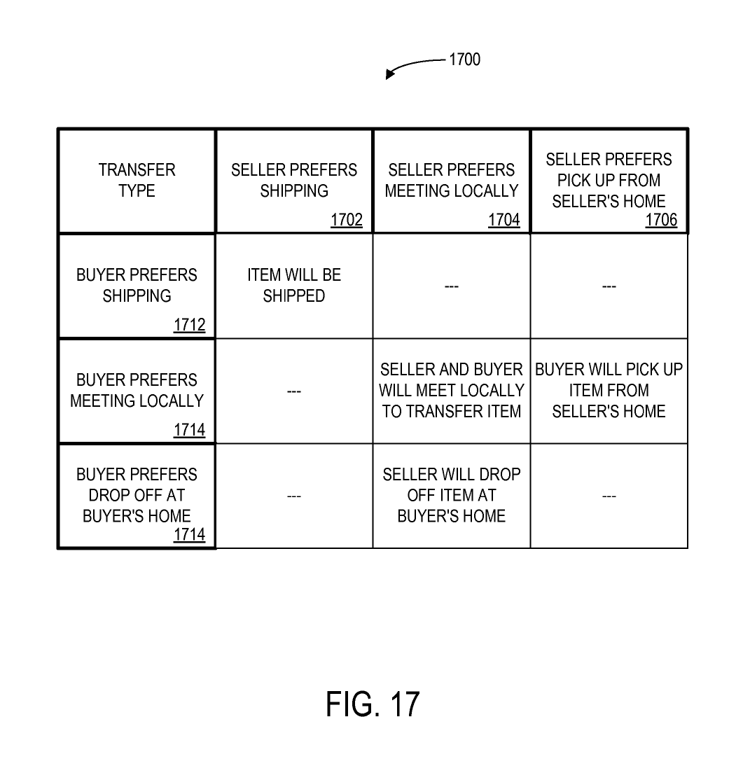

At 1602, it is determined how the item will be transferred from the buyer to the seller. One example of how such a determination may be made is provided with respect to FIG. 17.

According to one embodiment, a buyer and/or a seller may indicate how they would like to complete the transfer of the item (e.g., a preference on whether the item should be shipped or transferred in person). For example, a buyer might specify that he prefers an item to be shipped to his home address. The buyer may further specify that, in the event he must meet the seller in person to receive the item, he would prefer to do it on a Sunday afternoon at a location no more than five miles from his home address.

Using information received from the buyer and the seller (e.g., the transfer information 1110 associated with an OTB and the transfer information 1210 associated with an OTS), the controller 100 determines whether the item should be shipped or transferred in person. In one embodiment, the controller 100 attempts to find a transfer method that is satisfactory to both buyer and seller. If such a method cannot be found, the controller 100 may use a predetermined set of criteria to determine a transfer method. For example, the controller 100 may always determine that an item should be shipped when a seller prefers shipping and a buyer prefers an in-person transfer.

The controller 100 may also determine a transfer method based on prior experiences with different methods. For example, if in-person transfers have worked well in the past for a certain geographic region, the controller 100 may favor in-person transfers in that region. The controller 100 may also choose the transfer method based on deals with third parties. For example, UNITED PARCEL SERVICE® may pay the controller 100 to favor using a shipping method or a shopping mall may pay the controller 100 to be used as a meeting location (e.g., by paying a predetermined amount or by paying on a transaction-by-transaction basis).

Note that using a neutral location, such as a MCDONALD'S® restaurant, enables the controller 100 to extend the region over which buyers and sellers may be matched. For example, if buyers and sellers would normally only drive 20 miles to meet each other, having a buyer and seller meet at one of their homes restricts buyers and sellers to living within 20 miles of each other. However, if both the buyer and the seller will drive 20 miles to meet at a MCDONALD'S® restaurant, then the buyer and the seller may live as far apart as 40 miles.

Note that the controller 100 may use the buyer and seller transfer preferences to match an OTB and an OTS. That is, the controller 100 may determine how the item is to be transferred when a match is made, and if the buyer and the seller specifications have no mutually satisfactory transfer method, the OTB and the OTS may not be matched in the first place. In other embodiments, buyers and sellers only submit transfer preferences after matching or binding, possibly at the request of the controller 100. In this case, transfer preferences may not be a factor in matching or binding.

If the controller 100 determines that the item is to be transferred in person at 1602, appropriate transfer details may be determined. According to one embodiment, the controller 100 may instruct the buyer and the seller to determine the transfer details, including where and when to meet.

According to another embodiment of the present invention, the controller 100 determines these details, such as the time, day, and place of exchange. In establishing a meeting place for the buyer and the seller, the controller 100 may attempt to find a location convenient for either or both parties. To establish a meeting location, the controller 100 may retrieve the buyer's address 906 from the buyer database 900 and the seller's address 1006 from the seller database 900. The controller 100 may then consult a map database and employ an optimization algorithm to find a location best suited for satisfying a set of criteria. For example, the criterion may be for both the buyer and the seller to drive less than 20 miles (or 20 minutes) to reach the meeting place. Such criteria might derive from, for example, the buyer and seller transfer preferences or may be predefined by the controller 100. For example, the controller 100 may receive payment from a company to arrange meetings at locations associated with that company. In this case, one criterion would be to attempt to find a suitable company location. A further criterion may limit the number of meetings that occur at a particular location, discouraging impostors from waiting at a popular location with forged transfer codes. When the controller 100 has established transaction details, the information may be communicated, for example, to a seller device 200 and/or a buyer device 300.

The information provided to the seller and/or the buyer may include transaction guidelines, such as: who should initiate communication; a time frame in which the transaction is to be carried out; circumstances, such as a location and time of day, during which a transaction may be carried out; and a “protocol” for the transaction. The protocol may indicate, for example: the seller should initially hand the item to the buyer; the buyer has five minutes to inspect the item; if the buyer finds the item satisfactory, the buyer should communicate the transfer code to the seller; the seller should then verify that the code is valid; and, if the code is valid, the transaction is complete. According to one embodiment of the present invention, a penalty will be applied if either or both parties fail to comply with the protocol.

According to one embodiment, the controller 100 may provide some flexibility to the buyer and the seller with respect to the transfer. For example, the controller 100 may receive lists of acceptable times to meet from the buyer, the seller, or from both. The controller 100 may then attempt to find a time suitable for one or both parties, and direct the buyer and seller to meet at that time to carry out a transaction.

In some instances, the buyer and seller will meet at a home or work address. In these instances, meeting times need not be exact. For example, the controller 100 might tell the buyer to pick up an item at the seller's house sometime between 3:00 PM and 5:00 PM on November 16.

The controller 100 may also act as an intermediary between the buyer and the seller, while not actually participating in their negotiations. This may allow the buyer and the seller to preserve anonymity. For example, the buyer and the seller may exchange e-mail messages through the controller 100. In this case, the controller 100 may remove identifying information from the messages, so that the buyer and the seller only know each other as “buyer” and “seller.” In this way, the buyer and the seller may use anonymous communications to agree on whether or not to carry out a transaction. If the buyer and the seller are matched based on only a partial description of an item, the buyer may ask the seller (via the controller 100) for a more complete description of the item before deciding to complete the transaction. The buyer and the seller may also anonymously negotiate the circumstances of the transaction, such as meeting place and time. Furthermore, the buyer and seller may agree on aliases to use for each other at a meeting place. The controller 100 may also wish to prevent certain types of communications between the buyer and the seller. For example, if the controller 100 detects that the buyer and the seller are negotiating a way to exclude the system from a transaction, the controller 100 may end the negotiations, delete the information, provide a warning, and/or apply a penalty.

If the controller 100 decides that the item is to be transferred by shipment at 1602, then the controller 100 may determine shipping details to be followed. Such details may include: which delivery service should be used; the address to which the seller is to ship the item (e.g., the buyer's address or an address where the buyer can pick up the item); the date by which the item is to be sent or received; a type of delivery that should be used (e.g., standard or overnight); and/or how the item should be packed.

The shipping details may be based on, for example, information received from the buyer and/or the seller. For example, the seller may prefer UNITED PARCEL SERVICE® instead of FEDERAL EXPRESS®. Similarly, the controller 100 may use the seller's address to determine that the seller lives near a UNITED PARCEL SERVICE® outlet, and therefore arrange for the seller to use that delivery service. The controller 100 may also use predetermined shipping details, such as always requiring that an item be insured and shipped within two days after binding.

If the controller determines that the item is to be shipped to the buyer at 1602, a delivery code (e.g., a shipping tracking code) is received from the seller at 1604. According to anther embodiment, the controller 100 instead receives the delivery code from a delivery service device 400.

If the controller determines that the item is to be delivered to the buyer in person at 1602, a transfer code is generated for the transaction at 1606 and transmitted to the buyer. In this case, when the seller gives the item to the buyer, the buyer may provide the transfer code to the seller as a receipt. The seller can then submit the transfer code to the controller 100, proving to the controller 100 that the seller has given the item to the buyer. According to another embodiment, the seller does not provide the transfer code to the controller 100. Instead, the controller 100 assumes that the seller has given the item to the buyer, and the seller only needs to transmit the transfer code when there is a dispute (e.g., the buyer claims that he or she never received the item).

In another embodiment, the buyer signs a document when he or she receives the item from the seller. The seller may then give the document to the controller 100 in place of the transfer code. Alternatively, the seller may keep the document as proof that the buyer received the item.

The buyer and/or the seller may use the transfer code when communicating with the controller 100. The transfer code may allow the controller 100 to more easily identify the transaction in question. In one embodiment, the transfer code contains or encodes information describing the transaction. This information may include, for example: the buyer's name; the seller's name; the item being sold; the item's price; and/or the date of the transaction.

After the controller 100 receives the transfer code from the seller, the controller 100 can determine the code's validity. The controller 100 may, for example, compare the received transfer code to a transfer code 1316 stored in the transaction database 1300. The controller 100 may determine that the received transfer code is valid if, for example, the code is contained in the transaction database, the code has not previously been submitted, and the code corresponds to the proper transaction. If the controller 100 also receives a transaction identifier with the transfer code, then the controller 100 may look for the transfer code only under the transaction database 1300 entry corresponding to the submitted transaction identifier 1302. Once a transfer code is submitted, the controller 100 may record the submission by updating the date when transaction was completed 1320.

In an embodiment where the transfer code is encrypted, the controller 100 may apply a decrypting function and determine whether the decrypted code is valid. For example, if the output of the decrypting function is a sensible message, the transfer code may be determined to be valid.

In one embodiment, the controller 100 also transmits a partial transfer code to the seller. When the buyer presents a transfer code to the seller, the seller can use the partial transfer code to verify that he or she is receiving a valid transfer code. However, the seller cannot use the partial transfer code to recreate the transfer code, and thereby falsely claim to have given the item to the buyer. For example, a transfer code communicated to the buyer by the controller 100 might be “12345678” and a partial transfer code communicated to the seller might be “1x34xx7x.” The seller may then detect a false transfer code, such as “22743372,” by noting that the first and third digits do not match the partial transfer code. The seller, in turn, cannot fake the transfer code, because he or she does not know the second, fifth, sixth, and eighth digits. In a related embodiment, the buyer and seller might both receive partial transfer codes that combine to make a complete code. For example, the buyer may receive “the lamb walks silently - - - ” and the seller receives “ - - - through the woods at midnight.” The codes combine to read “the lamb walks silently through the woods at midnight.” Both the buyer and seller may then use the combined code to prove that the transaction was completed.

The controller 100 may generate codes for the buyer and the seller to allow them to identify each other. For example, the buyer and the seller might check each other's codes before completing a transaction to verify that neither is an impostor.

In one embodiment, the controller 100 generates a seller code to give to the seller. The seller then gives the seller code to the buyer along with the item. The buyer then provides the seller code to the controller 100. The seller code proves to the controller 100 that the buyer has completed the transaction, even if the seller fails to submit the transfer code. By submitting the seller code to the controller 100, the buyer may avoid any fines associated with not completing the transaction.

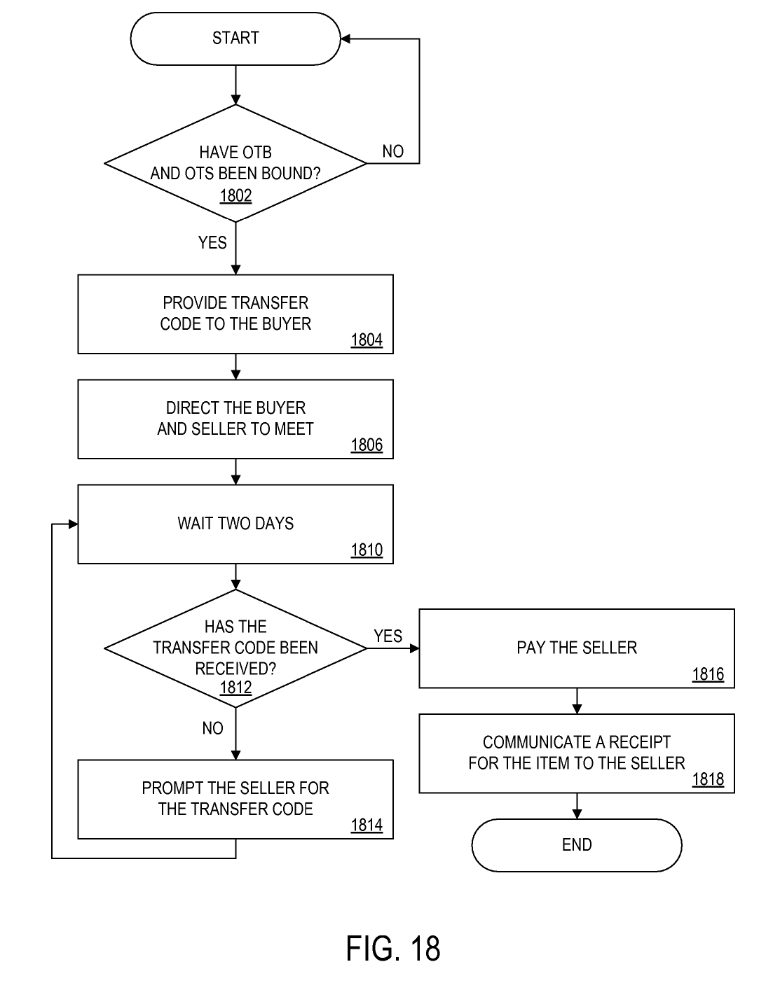

At 1608, it is determined if a prompt is required to be displayed to the buyer and/or the seller. One example of how such a determination may be made is provided with respect to FIG. 18. If required, an appropriate prompt is provided to the buyer and/or the seller at 1609.

For example, the controller 100 may prompt the buyer and/or the seller to solicit preferences of whether an item is to be shipped or transferred in person. Such a prompt may be provided, for example, when a buyer submits an OTB, when a seller submits an OTS, any time prior to binding, and/or a predetermined amount of time after binding.

The controller 100 may also prompt the buyer and/or the seller to inquire whether a buyer or the seller would change his or her preferences on whether an item should be shipped or transferred in person (e.g., when no mutually agreeable method of transferring the item was found). In this case, the controller 100 might offer compensation as an incentive for amending preferences. Such a prompt may be provided, for example, when the buyer submits an OTB, when a seller submits an OTS, any time prior to matching or binding, and/or a predetermined amount of time after binding

The controller 100 may also prompt the buyer and/or the seller to inform a buyer or a seller that a match has been found. Buyers and sellers may be informed, for example, a predetermined amount of time before or after binding, or any time prior to when the item is transferred.

The controller 100 may also prompt the buyer and/or the seller to inform the buyer that his or her method of payment for the item has been rejected. Such a prompt may be displayed, for example, a predetermined amount of time after the controller 100 has learned that the buyer's method of payment has been rejected.

The controller 100 may inform the seller that the binding of his or her OTS has been reversed. Such a prompt may be displayed, for example, a predetermined amount of time after the buyer's method of payment has been rejected or a predetermined amount of time after the controller 100 has received an indication that the buyer or seller refuses to carry out the transaction. Similarly, the controller 100 may inform the buyer that the binding of his or her OTB has been reversed. Such a prompt may be displayed, for example, a predetermined amount of time after the controller 100 has received an indication that the seller or buyer refuses to carry out the transaction.

The controller 100 may also prompt the buyer and/or the seller to provide a periodic update on the status of a transaction. Such a prompt may be displayed, for example, a predetermined amount of time after the submission of an OTB or an OTS, a predetermined amount of time after binding, a predetermined amount of time after the receipt of a buyer or a seller request to receive updates at a different frequency, a predetermined amount of time after the transfer code has been received, a predetermined amount of time after any funds have been transferred to or from the buyer or seller, a predetermined amount of time after a claim has been received, a predetermined amount of time after a complaint has been received, a predetermined amount of time after a claim has been resolved, a predetermined amount of time after a complaint has been resolved, and/or a predetermined time after the last periodic update was sent.

The controller 100 may also prompt the buyer and/or the seller to solicit preferences on the circumstances under which an item is to be transferred in person (e.g., an acceptable transfer time and place). Such a prompt may be displayed, for example, when the buyer submits an OTB, when a seller submits an OTS, any time prior to matching and binding, or a predetermined amount of time after binding.

The controller 100 may also prompt the buyer and/or the seller to direct them to complete the transfer of an item (e.g., providing the circumstances under which the transfer is to be performed). The prompt may also include buyer and seller contact information, enabling the buyer and the seller to arrange some of the circumstances of the transaction. Such a prompt may be displayed, for example, a predetermined amount of time after binding or a predetermined amount of time after receiving buyer and seller preferences on whether the item should be shipped or transferred in person.

The controller 100 may also prompt the buyer and/or the seller to provide an appropriate code (e.g., the transfer code, the partial transfer code, and/or the seller code). Such a prompt may be displayed, for example, a predetermined amount of time after binding or when the item is transferred. For example, the buyer and the seller might be in communication with the controller 100 via a wireless telephone during the transaction. In such a case, the controller 100 may provide the transfer code to the seller over the buyer's phone, so that the buyer never possesses the transfer code.

The controller 100 may also solicit a shipping tracking code from a seller. Along with the solicitation, the controller 100 may warn the seller that he or she will not receive payment until the shipping tracking code is submitted, and that he or she may be fined or otherwise penalized. The controller 100 may also inform the seller that he or she will receive periodic reminder e-mail messages to submit the shipping tracking code. If the buyer has agreed to pay shipping costs, the controller 100 may inform the seller that he or she will be reimbursed for shipping costs upon submission of the shipping tracking code. Such a prompt may be displayed, for example, a predetermined amount of time after binding. a predetermined amount of time after one or both of the buyer and the seller have submitted item transfer specifications, a predetermined amount of time after directing the seller as to how to carry out the transaction, a predetermined amount of time after a first solicitation for a shipping tracking code.

The controller 100 may also warn the seller to obtain shipping tracking codes in the future. The warning may be sent, for example, a predetermined amount of time after the seller has indicated that he or she shipped the item without obtaining a shipping tracking code. Similarly, the controller 100 may warn the seller to receive the transfer code from the buyer in the future. The warning may be sent a predetermined amount of time after the seller has indicated to the controller 100 that he or she delivered the item but did not obtain a transfer code from the buyer. Along with the warning, the controller 100 may inform the seller that he or she will not be paid until the buyer satisfaction period is expired without a buyer claim or complaint.

The controller 100 may also prompt the buyer to solicit input regarding the buyer's reception of the item and/or satisfaction with the item. The solicitation of the buyer's input may occur, for example, a predetermined amount of time after binding, a predetermined amount of time after directing the buyer and seller as to how to carry out the transaction, a predetermined amount of time after receiving a transfer code from the seller, a predetermined time after receiving a shipping tracking code from the seller, a predetermined amount of time after having received an indication from the seller that the seller delivered the item, and/or a predetermined amount of time after binding where the seller has never indicated having delivered the item.

The controller 100 may also prompt the seller to solicit a transfer code. The solicitation may be accompanied by a warning that informs the seller that he or she risks being fined or not being paid for the item if the seller does not submit the transfer code. Along with the solicitation, the controller 100 may inform the seller that the controller 100 will send the seller periodic e-mail messages to remind the seller to submit the transfer code. The seller may be solicited for a transfer code, for example, a predetermined amount of time after binding, a predetermined amount of time after directing the buyer and seller as to how to carry out the transaction, a predetermined amount of time after communicating the transfer code to the buyer, and/or a predetermined time after soliciting the transfer code from the seller and not receiving the seller's response.

The controller 100 may also prompt the buyer and/or the seller to inquire about an invalid transfer code a predetermined amount of time after finding a submitted transfer code to be invalid or a predetermined amount of time after having previously inquired about an invalid transfer code without receiving a satisfactory response.

The controller 100 may also solicit a seller code from the buyer. The solicitation may be accompanied by a warning that informs the buyer that he or she risks being fined if a seller code is not submitted. The buyer may be solicited for the seller code, for example, a predetermined amount of time after binding, a predetermined amount of time after directing the buyer and seller as to how to carry out the transaction, a predetermined amount of time after communicating the seller code to the seller, and/or a predetermined time after soliciting the seller code from the buyer and not receiving the seller's response.

The controller 100 may also inquire whether the seller wants to receive a cash advance upon binding. Such an inquiry may occur, for example, a predetermined amount of time after receiving the OTS from the seller or a predetermined amount of time after binding.

The controller 100 may also solicit claim information from the buyer, such as the date the buyer received the item, and/or why the buyer does not want the item. Such claim information may be solicited, for example, if the buyer has expressed dissatisfaction with the item within a predetermined amount of time after the bind date or after having received the item. The date of receipt may be based on, for example, the buyer's word, the seller's word, and/or information obtained using the shipping tracking codes. Such claim information may also be solicited, for example, (i) if the buyer has expressed dissatisfaction with the item within a first predetermined amount of time after the bind date and within a second predetermined amount of time after having received the item, (ii) if the buyer has previously communicated claim information and the controller 100 wishes the buyer to confirm the information, and/or (iii) a predetermined amount of time after receiving a buyer complaint relating to a buyer dissatisfaction claim.

The controller 100 may also solicit warranty claim information from the buyer, such as the date the buyer received the item and what fault the buyer finds with the item. The warranty claim information may be solicited, for example: (i) if the buyer has expressed dissatisfaction with the item within a predetermined amount of time after the bind date; (ii) if the buyer has expressed dissatisfaction with the item within a predetermined amount of time after having received the item. The date of receipt may be determined according to one or more of: the buyer's word, the seller's word, and information obtained using the shipping tracking codes. Similarly, the warranty claims information may be solicited: (i) if the buyer has expressed dissatisfaction with the item within a first predetermined amount of time after the bind date and within a second predetermined amount of time after having received the item; and/or (ii) a predetermined amount of time has elapsed after the controller 100 has received a buyer complaint involving a warranty.

The controller 100 may also solicit confirmation of claim information already submitted by the buyer or seller. The controller 100 may additionally communicate a unique claim identifier number and a message explaining the expected processing times. Such a solicitation for confirmation may occur, for example, a predetermined amount of time after the controller 100 has received a claim from the buyer or the seller.

The controller 100 may also prompt the buyer and/or the seller to indicate that a buyer satisfaction claim has been processed, resulting in an acceptance, a partial acceptance, or a rejection (e.g., after being reviewed by an operator associated with the controller 100). This prompt may, for example, solicit preferences from the buyer and the seller on how the item is to be returned. The prompt may also include the amounts of any refunds to the buyer or funds to be withheld or deducted from the seller's account. Such a prompt may be displayed, for example, a predetermined amount of time after the buyer has submitted a buyer satisfaction claim or a predetermined amount of time after the buyer has submitted information necessary to process a buyer satisfaction claim.

The controller 100 may also prompt the buyer and/or the seller to indicate that a warranty claim has been processed, resulting in an acceptance, a partial acceptance, or a rejection. Such a prompt may include the amount of any refund to the buyer or funds withheld or deducted from the seller's account. Such a prompt may be displayed, for example, a predetermined amount of time after the buyer has submitted a warranty claim or a predetermined amount of time after the buyer has submitted information necessary to process a warranty claim.

The controller 100 may also ask the buyer and the seller whether certain measures, taken in response to a claim or complaint, would be acceptable. For example, if the buyer has complained that the item he or she received from the seller does not work properly, or that the item is different from what he or she expected, the controller 100 may ask the buyer whether he or she would like to keep the item and receive a partial refund. The controller 100 may similarly ask the seller whether the seller would accept a percentage of the original bind price as payment, while still allowing the buyer to keep the item. The controller 100 may ask the buyer or seller whether the item can be donated to charity, while possibly giving the seller credit for a charitable donation. The controller 100 might ask the buyer whether he or she would be willing to bring the item to a repair shop, with part of all of the repairs paid for by the seller, the controller 100, or the repair shop through a deal with the controller 100. If the item has been resold to a new buyer, the first buyer may be asked whether he or she would be willing to ship or deliver the item to the new buyer. The controller 100 may make such inquiries, for example, a predetermined amount of time after receiving a buyer or seller claim, a predetermined amount of time after accepting or partially accepting a claim, a predetermined amount of time after the OTB or the OTS is submitted, a predetermined amount of time after binding, and/or a predetermined amount of time after receiving a transfer code or shipping tracking code.

The controller 100 may also direct the buyer to return the item to the seller. For example, the controller 100 may instruct the buyer to ship the item or may direct a personal transfer. Such a prompt may be displayed, for example, a predetermined amount of time after the approval of a buyer satisfaction or warranty claim, a predetermined amount of time after receiving preferences from the buyer or seller on how the item should be returned, a predetermined amount of time after soliciting preferences from the buyer or seller on how the item should be returned, but receiving no response.

The controller 100 may also prompt the buyer and/or the seller to ask if an item has been returned. Such a prompt may be displayed, for example, after a transaction has been reversed, due to some claim or complaint or a predetermined amount of time after the controller 100 has directed the buyer and seller to reverse a transaction.

The controller 100 may also direct the buyer to donate the item to charity. The controller 100 may instruct the buyer on how to donate the item (e.g., by providing a shipping address for the charity and designating a shipping company or by providing a location to which the buyer can personally deliver the item). The controller 100 may further instruct the buyer to obtain a receipt for the donation of the item, and may instruct the original buyer to submit the receipt to the controller 100 in order to receive a refund for the item. The controller 100 may direct the buyer to donate the item to charity, for example, a predetermined amount of time after the submission or acceptance of a buyer claim or complaint, a predetermined amount of time after the rejection of a seller's appeal to a buyer's claim or complaint, a predetermined amount of time after the seller agrees to have the item donated to charity, or a predetermined amount of time after the buyer agrees to donate the item to charity. Such a prompt may also be displayed, for example, at a time when the charitable donation would be most helpful to the buyer, seller, or controller 100. For example, the controller 100 might instruct the buyer to wait until the next calendar year before making the donation in order to receive tax breaks for that year.

The controller 100 may also inquire whether the buyer has submitted the item to charity. The controller 100 may further warn the buyer that the buyer will not receive a refund for the item until the buyer has given the item to a charity and possibly submitted a receipt. Such a prompt may be displayed, for example, a predetermined amount of time after instructing the buyer to deliver the item to charity.

The controller 100 may also direct the buyer to submit the item to a repair shop. The controller 100 may instruct the buyer on how to submit the item, by providing a shipping address for the repair shop and designating a shipping company or by providing a location to which the buyer can personally deliver the item. The controller 100 may further instruct the buyer to obtain a receipt for the repair of the item, and may instruct the buyer to submit the receipt to the controller 100 in order to receive a refund for the repair of the item. Such a prompt may be displayed, for example, a predetermined amount of time after the submission or acceptance of a buyer claim or complaint, a predetermined amount of time after the rejection of a seller's appeal to a buyer's claim or complaint, a predetermined amount of time after the seller agrees to pay for the repair of the item, and/or a predetermined amount of time after the buyer agrees to have the item repaired.

The controller 100 may also inquire whether the buyer has submitted the item for repair. The controller 100 may further warn the buyer that the buyer will not receive reimbursement for repairs until the buyer has submitted a receipt. Such a prompt may be displayed, for example, a predetermined amount of time after instructing the buyer to deliver the item to charity.

The controller 100 may also direct the buyer to transfer the item to a new buyer. The controller 100 may instruct the buyer on how to transfer the item, by providing a shipping address for the new buyer and designating a shipping company or by providing a location to which the buyer can personally deliver the item. The controller 100 may also facilitate the transfer by providing contact information and allowing the buyers to negotiate the circumstances of the transfer in a process similar to the one already described for the buyer and seller. The controller 100 may further instruct the original buyer to obtain a code or other indication of a completed transfer, and may instruct the buyer to submit the code to the controller 100 in order to receive a refund for the item. Such a prompt may be displayed, for example, a predetermined amount of time after the submission or acceptance of a buyer claim or complaint, a predetermined amount of time after the rejection of a seller's appeal to a buyer's claim or complaint, a predetermined amount of time after the seller is re-matched and bound with a new buyer, and/or a predetermined amount of time after the buyer agrees to transfer the item to a new buyer.

The controller 100 may also ask the buyer if he or she has transferred the item to a new buyer yet. The controller 100 may further warn the buyer that the buyer will not receive reimbursement for the item until the buyer has submitted an indication that the buyer has transferred the item. The controller 100 may inquire whether the item has been transferred, for example, a predetermined amount of time after the seller has been re-matched with a new buyer and the controller 100 has instructed the original buyer to transfer the item to the new buyer.

The controller 100 may also query the seller in response to a buyer complaint. Such a query may occur, for example, a predetermined amount of time after the buyer complains about never having received an item. The query may then ask the seller what has become of the item. Such a prompt may also be displayed, for example, a predetermined amount of time after the buyer has complained that the buyer and seller have been unable to agree on circumstances for transferring the item. The controller 100 may ask about the problem, and may ask whether the seller wishes the controller 100 to determine circumstances for the transfer of the item.

The controller 100 may also prompt the seller to respond to a buyer's complaint. Such a response may occur, for example, a predetermined amount of time after the controller 100 has received a response from a seller regarding the status of an item that has not been received by the buyer. The controller 100's response may inform the buyer either that the item is on its way or that the item is not coming. In the latter case the controller 100 may inform the buyer that he is to receive a refund. Such a prompt may be displayed, for example, a predetermined amount of time after the buyer has complained that the buyer and seller have been unable to agree on circumstances for transferring the item. The controller 100 may ask about the problem, and may ask whether the buyer wishes the controller 100 to determine circumstances for the transfer of the item.

The controller 100 may also query the buyer in response to a seller complaint. Such a query may occur, for example, a predetermined amount of time after the seller has complained that the buyer and seller have been unable to agree on circumstances for transferring the item. The controller 100 may ask about the problem, and may ask whether the buyer wishes the controller 100 to determine circumstances for the transfer of the item.

The controller 100 may also prompt the buyer to respond to a seller's complaint. Such a response may occur, for example, a predetermined amount of time after the seller has complained that the buyer and seller have been unable to agree on circumstances for transferring the item. The controller 100 may ask about the problem, and may ask whether the seller wishes the controller 100 to determine circumstances for the transfer of the item.

The controller 100 may also prompt the seller to solicit the seller for information regarding the appeal of a processed buyer claim. Such a solicitation may occur, for example, a predetermined amount of time after the seller has submitted an appeal of a buyer's claim or in order to have the seller verify information previously submitted in an appeal.

The controller 100 may also prompt the buyer and/or the seller regarding the status of a claim (e.g., a buyer satisfaction claim, a warranty claim, or a seller's appeal of a buyer's claim). The status of a claim might be one of, for example, “being processed” or “resolved.” The controller 100 may inform a buyer or seller of the status of a claim if, for example, a buyer or seller contacts the controller 100 inquiring about the status of a claim or the buyer or seller provide satisfactory identifying information, such information possibly including a name, e-mail message address, social security number, secret password, transfer code, shipping tracking code, and transaction identifier. Such a prompt may also be displayed, for example, when the claim has been resolved or a predetermined amount of time has elapsed since the claim was submitted.

The controller 100 may also prompt the buyer and/or the seller to provide a receipt for a funds transaction. A receipt may be provided, for example, a predetermined amount of time after payment for the item has been taken from the buyer or a predetermined amount of time after funds have been transferred to or from the buyer or seller, the transferred funds possibly going to a buyer or seller cash card account.

The controller 100 may also prompt the seller to provide a receipt for having transferred the item to the buyer. The receipt may be provided, for example, a predetermined amount of time after the buyer has confirmed the arrival of the item, a predetermined amount of time after funds have been given to the seller as payment for the item, and/or a predetermined amount of time after funds have been given to the seller in conjunction with a promotional offer.

The controller 100 may also ask the seller whether he wants to resell an item. The seller may be asked, for example, a predetermined amount of time after the transaction has been reversed. Similarly, the controller 100 may also ask the buyer, after a transaction has been reversed, whether he or she wants to maintain the OTB in the hopes of getting re-matched. The buyer may further be asked whether he or she wishes to modify the OTB. The buyer may be asked, for example, a predetermined amount of time after the transaction has been reversed.

The controller 100 may also solicit feedback from the buyer and/or the seller about the transaction system 700. Such feedback may be solicited at any time.

The controller 100 may also inform the buyer or the seller that a claim has been canceled. The buyer or the seller may be informed, for example, a predetermined amount of time after the buyer or seller has indicated a desire to cancel a previously submitted claim to the controller 100. For example, a buyer may submit a buyer satisfaction claim, but later change his mind and decide that he or she likes the item.

The controller 100 may also provide an itemized list of the amounts charged and credited to an account. For example, a seller who pays a $5 commission to post an item for sale, and who receives $300 from the sale of the item, may have $295 credited to his account. However, the seller may desire a list of the components of the credited amount, i.e., “$300 sale price; −$5 commission.” Alternatively, the controller 100 may communicate the itemized list to the seller's credit card issuer, or may break up the $295 into its component fund transfers of subtracting $5 and crediting $300, such that the transfers show up separately on the seller's credit card statement. The controller 100 may communicate an itemized funds transfer list, for example, a predetermined amount of time after funds are transferred to or taken from a buyer or seller or a predetermined amount of time after all funds transfers associated with a transaction are complete.

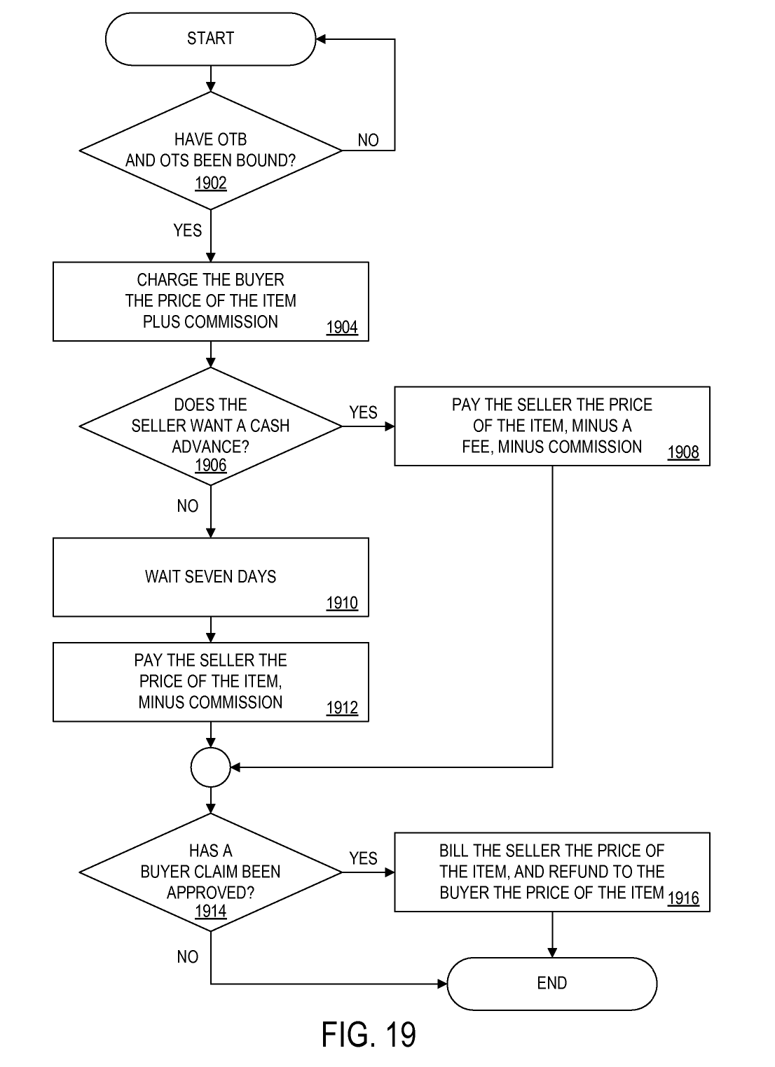

At 1610, it is determined if a transfer of funds is required (e.g., a transfer of funds to, or from, the buyer and/or the seller). One example of how such a determination may be made is provided with respect to FIG. 19. If required, an appropriate funds transfer is performed at 1611.

For example, the controller 100 may transfer funds to and from the buyer and seller's credit card accounts, checking accounts, debit card accounts, and/or smart cards. The controller 100 may also transfer funds via a money order, a travelers check, a cashier's check, and/or cash. In some embodiments, “funds” may include stamps, Web site currencies, frequent flyer miles, securities, merchant discounts, or anything else of value.

The controller 100 may transfer funds, for example, to collect payment for the item from the buyer. Payment may be collected, for example, a predetermined amount of time after the buyer submits the OTB, a predetermined amount of time after the seller submits the OTS, a predetermined amount of time after binding, a predetermined amount of time after paying the seller for the item, a predetermined amount of time after the seller submits a transfer code, a predetermined amount of time after the buyer expresses satisfaction with the item, and/or a predetermined amount of time after the buyer receives the item, with the date of receipt being based on the buyer's word or information obtained through the use of shipping tracking codes.

The controller 100 may also transfer funds to pay the seller for the item. The seller may be paid, for example, a predetermined amount of time after the seller submits the OTS, a predetermined amount of time after the buyer submits the OTB, and/or a predetermined amount of time after binding. The seller may be paid even if the controller 100 receives no transfer code or other indication of the item's being transferred, so long as the controller 100 receives no buyer complaints. The seller may also be paid, for example, a predetermined amount of time after the controller 100 either learns or determines that the item is to be transferred via shipment. According to another embodiment, the seller is paid a predetermined amount of time after the controller 100 either learns or determines that the item is to be transferred personally. The amount of time the controller 100 waits before paying a seller who shipped an item may be different from the amount of time the controller 100 waits before paying a seller who transferred the item in person. For example, the controller 100 may wait longer for a shipment to occur in order to give the buyer time to receive and inspect the item. According to other embodiments, the seller may be paid a predetermined amount of time after the seller submits a transfer code, a predetermined amount of time after the controller 100 determines a seller-submitted transfer code to be valid, and/or a predetermined amount of time after the controller 100 determines a transfer code to be both valid, and to correspond to the particular transaction for which a seller is to be paid. For example, a seller might have two transactions in progress, and try to use the transfer code for a transaction involving a cheap item to get paid for a transaction involving an expensive item.

The controller 100 may also arrange for the seller to receive a payment a predetermined amount of time after the buyer expresses satisfaction with the item, or a predetermined amount of time after the buyer receives the item, with the date of receipt being based on the buyer's word or information obtained through the use of shipping tracking codes.

The controller 100 may also transfer funds to provide the seller with a cash advance on the payment for the item. The cash advance may be given, for example, if the seller gives an indication of wanting a cash advance, if the seller indicates a willingness to pay a fee for the cash advance, if the bind price of the item meets certain criteria (e.g., the bind price exceeds a certain threshold or the bind price is less than a certain threshold), and/or if the seller's record maintained by the controller 100 indicates that the seller is permitted to receive a cash advance. The absence of a marker, such as a “yellow card,” may provide such an indication. The cash advance may also be given a predetermined amount of time after the seller submits the OTS, a predetermined amount of time after the buyer submits the OTB, a predetermined amount of time after binding, a predetermined amount of time after the seller submits a transfer code, a predetermined amount of time after the buyer expresses satisfaction with the item, and/or a predetermined amount of time after the buyer receives the item, with the date of receipt being based on the buyer's word or information obtained through the use of shipping tracking codes.

The controller 100 may also transfer funds to collect a commission from the buyer in exchange for facilitating the transaction. Such a commission may be collected, for example, a predetermined amount of time after the buyer submits the OTB, a predetermined amount of time after binding, a predetermined amount of time after the seller submits a transfer code, a predetermined amount of time after the buyer expresses satisfaction with the item, and/or a predetermined amount of time after the buyer receives the item. The controller 100 may similarly transfer funds to collect a commission from the seller.

The controller 100 may also transfer funds to refund money to the buyer. Money may be refunded to the buyer, for example, a predetermined amount of time after the approval or partial approval of a buyer satisfaction claim. A buyer satisfaction claim may be approved if certain conditions are met, such as: the buyer makes the claim within a predetermined amount of time after binding; the buyer does not receive the item within a predetermined amount of time after binding; the buyer makes the claim within a predetermined amount of time after receiving the item; the item the buyer received is materially different from what the buyer specified in the OTB; the item the buyer received was not in good working order on the date of receipt; the item the buyer received broke within a predetermined amount of time of the date of receipt; the buyer is unsatisfied with the transaction and does not want to keep the item; and/or the number and nature of buyer claims previously submitted by the buyer meet certain criteria, such criteria possibly including: the buyer has submitted fewer than a predetermined number of claims relating to the current transaction, and the buyer has submitted fewer than a predetermined number of claims in a predetermined period of time. For example, the buyer may not make duplicate claims for the same item, and the buyer may not make more than three claims a year. A buyer claim may also be approved, for example, a predetermined amount of time after the approval or partial approval of a buyer warranty claim. A buyer warranty claim may be approved based on conditions similar to those described with respect to a buyer satisfaction claim.

The controller 100 may also transfer funds to provide the seller with a payment associated with a promotional offer (e.g., a subsidy). An example of a promotional offer is for the seller to receive twenty dollars more than an OTS asking price if he or she applies for a new credit card. A payment associated with a promotional offer may be provided to the seller, for example, a predetermined amount of time after conditions of the promotional offer are met, such as: the seller's OTS being bound, the seller's OTS being bound within a certain amount of time, the seller's OTS being bound at a certain price, or within a certain range of prices, the OTS being bound with a buyer who accepts another promotional offer, the item is transferred, the buyer has paid for the item, the buyer has not expressed dissatisfaction with the item for a certain length of time, and/or the controller 100 has received the transfer code. Similarly, the controller 100 may transfer funds to provide the buyer with a payment associated with a promotional offer.

The controller 100 may also transfer funds to receive the seller's cost of shipping from the buyer, or to deduct such an amount from a refund given to the buyer. Shipping costs may be taken from the buyer, for example, if the buyer has agreed to pay shipping costs for the item: a predetermined amount of time after the seller has submitted a shipping tracking code; a predetermined amount of time after a buyer satisfaction claim is approved; and/or if the buyer does not submit a complaint. Similarly, the controller 100 may transfer funds from the seller based on the buyer's cost of shipping.

The controller 100 may also transfer funds to take back a payment given to the seller. Money may be taken back from the seller, for example, a predetermined amount of time after a buyer has complained about not having completed a transaction with the seller. For example, the seller may have failed to meet the buyer for the item's transfer or the item may not have come in the mail. Money may also be taken back from the seller a predetermined amount of time after the approval or partial approval of a buyer satisfaction or buyer warranty claim, a predetermined amount of time after a buyer claim has been approved, and the controller 100 has attempted to resell the item, but has not succeeded, a predetermined amount of time after any buyer or seller claim, complaint, or dispute has been settled through arbitration, mediation, or mutual agreement in favor of retaking payment from the seller, a predetermined amount of time after the buyer has indicated, via shipping tracking code or otherwise, that the buyer has returned the item to the seller, a predetermined amount of time after the seller has indicated that the item has been returned, and/or a predetermined amount of time after the buyer has indicated, through receipt or otherwise, that the item has been donated to charity.

The controller 100 may also transfer funds to apply a penalty to the buyer. For example, the buyer may be fined by deducting funds from a buyer's financial account, by sending the buyer a bill, or by deducting the amount of the fine from an amount to be paid to the buyer. For example, if the buyer is fined and the buyer also receives a faulty item from the seller, the buyer may be refunded the bind price of the item minus the amount of the fine. The buyer may be fined, for example, a predetermined amount of time after the buyer fails to submit a seller code, a predetermined amount of time after the buyer has been reminded to submit the seller code but has still failed to submit the seller code, a predetermined amount of time after the controller 100 has ascertained, via seller complaint or otherwise, that the buyer has refused to carry out the transaction, a predetermined amount of time after the controller 100 receives excessive, frivolous, or fraudulent buyer claims or complaints, and/or a predetermined amount of time after a seller claim or complaint is approved.

The controller 100 may also transfer funds to apply a penalty to the seller. For example, the seller may be fined a predetermined amount of time after the seller fails to submit a transfer code, a predetermined amount of time after the seller has been reminded to submit the transfer code but has still failed to submit the transfer code, a predetermined amount of time after the controller 100 has ascertained, via buyer complaint or otherwise, that the seller has refused to carry out the transaction, a predetermined amount of time after the controller 100 receives excessive, frivolous, or fraudulent seller claims or complaints, and/or a predetermined amount of time after a buyer claim or complaint is approved.

The controller 100 may also transfer funds to reverse the transfer of funds carried out in accordance with the processing of a claim. Such a reversal of a funds transfer may occur, for example, a predetermined amount of time after a buyer or seller has canceled a claim or a complaint that he previously submitted. For example, a buyer satisfaction claim might be approved, resulting in the controller 100 paying the buyer a refund. However, the buyer may later cancel the claim, expressing a newfound satisfaction with the item. The controller 100 may then reverse the refund given to the buyer by taking funds from the buyer.

According to one embodiment, the controller 100 may “freeze” seller funds if the seller is paid for the item. Funds may be frozen in a credit card account, for example. The funds may remain frozen for a predetermined amount of time. If the buyer later files a claim or complaint about the item, payment for the item may be taken back from the frozen funds.

In some embodiments, rather than charging the buyer for the item a predetermined amount of time after binding, the controller 100 may freeze buyer funds. If the controller 100 later receives the transfer code, the shipping tracking code, an indication of buyer satisfaction, or some other indication that the transaction has been completed, then the controller 100 may collect payment from the frozen funds.

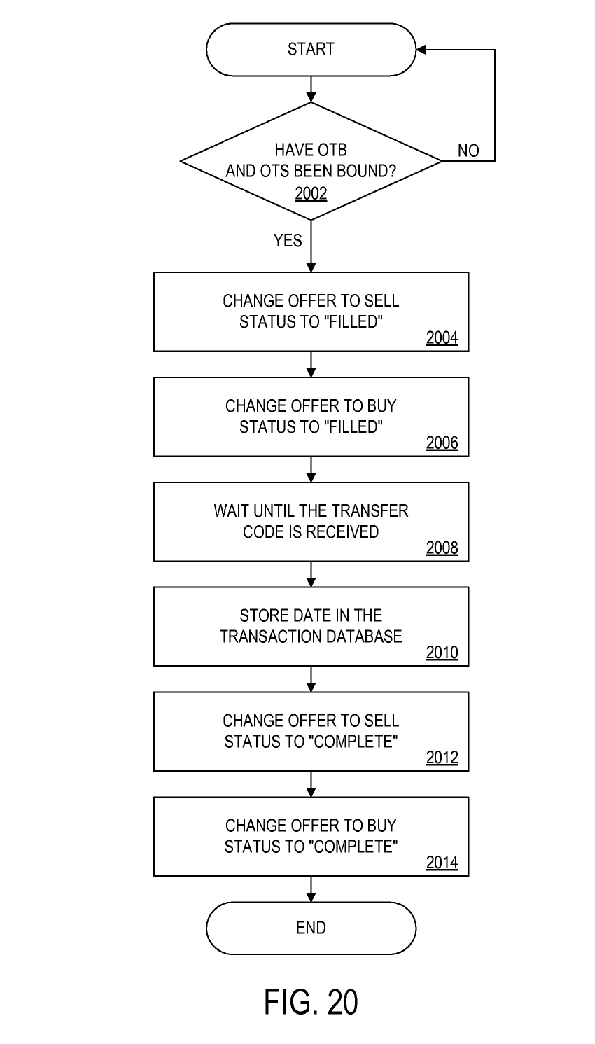

At 1612, it is determined if a database update is required. One example of how such a determination may be made is provided with respect to FIG. 20. If an update is required, the appropriate database(s) are updated at 1613.

By way of examples of information stored in databases that may be updated during a transaction, the offer to buy database 1100 and the offer to sell database 1200 store the status 1114, 1216 of an offer. The status may be one of “open,” “pending,” “filled,” “complete,” or “expired.” The transaction database 1300 stores the price 1308 at which an OTB and OTS were bound and the date when the transaction was completed 1320. The transaction claim database 1400 stores the status 1412 of a claim, the submission date 1406, the decision date 1414, the action taken 1416, and the dollar amount paid 1420.

A database may be updated, for example, when a seller indicates an interest in a buyer's OTB. In this case, the status 1114 stored in the offer to buy database 1100 is updated from “open” to “pending.” The “pending” status tells other sellers that the buyer's OTB may become available if the first seller chooses not to bind the OTB.

A database may also be updated when an OTS and an OTB are bound. In this case, the status 1216 in the offer to sell database 1200 is updated to “filled” and the status 1114 stored in the offer to buy database 1100 is updated to “filled.” Moreover, a new transaction record is created in the transaction database 1300 with a new transaction identifier 1302, the appropriate offer to sell identifier 1304, offer to buy identifier 1306, price 1308, and fill date 1310.

A database may also be updated when the controller 100 receives or determines transaction details. For example, if the item is to be shipped the shipping details 1314 stored in the transaction database 1300 is updated to indicate the shipping carrier, the date on which the item is to be shipped, the mode of shipping, and/or other details. If the item is to be transferred in person, the transfer details 1312 stored in the transaction database 1300 is updated to indicate the date and time of the transfer, the location of the transfer, and/or a transfer protocol.

A database may also be updated when the buyer's method of payment is rejected. In this case, the status field 1114 stored in the offer to buy database 1100 is updated to “suspended.” If the buyer has other outstanding offers, their status 1114 may also be updated to “suspended.” The flags 1116 are updated to indicate “payment rejected,” which may trigger an e-mail message to be sent to the buyer and/or the seller. The status 1216 stored in the offer to sell database 1200 is updated to “open,” and the appropriate record in the transaction database 1300 may be deleted.

A database may also be updated when a buyer, whose method of payment had previously been rejected, submits a new method of payment, the new method of payment possibly being identical to the old, except with the reason for rejection having been resolved. For example, if a buyer's first credit card is rejected, the buyer might submit a second credit card, or might resolve the problem with the first credit card and resubmit the first credit card. As a result, the status 1114 stored in the offer to buy database 1100 may be updated to “open.”

A database may also be updated when a predetermined amount of time elapses after one or more of: the transfer code is received, the shipping tracking code is received, the buyer's expression of satisfaction with the item is received, the OTS and OTB are bound, the seller is paid, and/or payment is collected from the buyer. In this case, the date when transaction was completed 1320 (stored in the transaction database 1300) is updated to record the date at which the transfer code was received. The status 1216 stored in the offer to sell database 1200 is updated to “complete,” the status 1114 stored in the offer to buy database 1100 is updated to “complete.”

A database may also be updated when the buyer engages in misconduct. In this case, the status 1322 of the transaction is updated to “suspended,” the status 1216 of the OTS is updated to “open,” the status 1114 of the OTB is updated to “suspended,” the penalties 922 in the buyer database 900 is updated to “yellow card” for minor misconduct and “red card” for major misconduct, and the penalty explanation 924 is updated with a written explanation of the buyer's misconduct.

A database may also be updated when the seller engages in misconduct. In this case, the status 1322 of the transaction is updated to “suspended,” the status 1216 of the OTS is updated to “suspended,” the status 1114 of the OTB is updated to “open,” the penalties 1022 in the seller database 1000 is updated to “yellow card” for minor misconduct and “red card” for major misconduct, and the penalty explanation 1024 is updated with a written explanation of the seller's misconduct.

A database may also be updated when the buyer or seller submits a claim (e.g., a complaint about an item). In this case, a new record is created in the transaction claim database 1400 along with a newly created claim identifier 1402 and the submission date 1406. The buyer identifier 9002 or the seller identifier 1002 associated with the claim is stored via the claim originator 1404 as appropriate. The claim type 1408 is updated to reflect that the claim is associated with “buyer satisfaction,” “warranty,” or “seller appeal” and a code is stored in the reason type 1410 indicating what the claim is about. For example, a “1” might indicate that the item was broken when the buyer received the item. The status 1412 is updated to “being processed.” In addition, the claims 920, 1020 associated with the buyer or seller is updated to include the claim identifier 1402 from the transaction claim database 1400. Similarly, the associated claims 1318 stored in the transaction database 1300 is updated to reflect the claim identifier 1402.

A database may also be updated when a buyer claim is accepted. In this case, the status 1322 in the transaction database 1300 is updated to “reversed” and the status 1412 in the transaction claim database 1400 is updated to “accepted.” The decision date 1414 is updated to reflect the date the claim was accepted.

A database may also be updated when a seller claim is accepted, such as when the seller's claim successfully reverses the prior acceptance of a buyer satisfaction or a buyer warranty claim. In this case, the status 1322 in the transaction database 1300 is updated to “filled” and the status 1412 in the transaction claim database 1400 associated with the seller's claim is updated to “accepted.” The status 1412 associated with the buyer's claim that was reversed is updated to “reversed.”

A database may also be updated when a claim is denied. In this case, the status 1412 stored in the transaction claim database 1400 is updated to “denied,” and the decision date 1414 is updated based on the current date.

A database may also be updated when the controller 100 determines an appropriate action to take in response to a claim's acceptance or denial. In this case, the action taken 1416 is updated to reflect the appropriate action and the action status 1418 is updated to “incomplete” (e.g., the action has not yet been taken).

A database may also be updated when an action initiated by the controller 100 is completed. For example, if the action was, “return the item,” the action may be completed when the seller indicates that the buyer has returned the item. In this case, the action status 1418 is updated to “complete.” In some cases, the dollar amount paid 1420 may be updated, such as to include a payment amount.

A database may also be updated when the controller 100 receives an indication from a party (a buyer or a seller) that the party wishes to cancel a previously submitted claim. For example, the buyer may have previously submitted a buyer satisfaction claim citing an item that does not work. However, the buyer may since have figured out how to work the item, and wish to reverse the claim. In this case, the status 1412 is updated to “reversed.”

FIG. 17 is a table 1700 illustrating transfer types and preferences according to an embodiment of the present invention. Such a table 1700 may be used, for example, when the controller 100 determines how an item will be delivered from a seller to a buyer.

In particular, the table 1700 contains entries related to the following seller preferences: seller prefers shipping 1702, seller prefers meeting locally 1704, and seller prefers pick up from seller's home. Similarly, the table 1700 contains entries related to the following buyer preferences: buyer prefers shipping 1712, buyer prefers meeting locally 1714, and buyer prefers drop off at buyer's home 1714.

As can be seen in the table 1700, when one party prefers shipping and the other party finds shipping acceptable, the controller 100 will arrange for the item to be shipped from the seller to the buyer. When the buyer wants the item delivered to his or her home and the seller is willing to meet the buyer at a local destination, the seller may deliver the item to the buyer's home. Similarly, if the buyer will pick up the item locally and the seller wants the buyer to pick up the item at the seller's home, the buyer can pick up the item at the seller's home. If the buyer will pick up the item locally and the seller is willing to drop the item off at a local destination, the seller and buyer can meet locally to transfer the item.

Note that in some cases, both the seller's preference and the buyer's preference cannot be satisfied (e.g., the seller prefers to have the item picked up from the seller's home the buyer prefers to have the item delivered to the buyer's home). In this case, the controller 100 may not match an OTS with an OTB or may ask one of the parties if another transfer type would be acceptable.

FIG. 18 is a flow chart of a method performed when an OTS is bound with an OTB according to an embodiment of the present invention. In particular, FIG. 18 illustrates a determination of whether a prompt should be displayed to a buyer and/or a seller. If the buyer's OTB and seller's OTS have been bound at 1802 (i.e., the buyer's OTB has been matched with the seller's OTS), a transfer code is provided to the buyer at 1804. The controller 100 also directs the buyer and the seller to meet at 1806.

At 1810, the controller 100 then waits for two days to allow the seller time to transmit the transfer code. If no transfer code has been received from the seller at 1812, a prompt is displayed to the seller reminding him or her that a transfer code should be provided at 1814. When a transfer is received from the seller at 1812, the seller is paid at 1816 and a receipt may be communicated to the seller at 1818.

FIG. 19 is a flow chart of a method performed when an offer to sell is bound with an offer to buy according to another embodiment of the present invention. In particular, FIG. 19 illustrates a determination of whether or not funds should be transferred to or from the buyer and/or the seller. If the OTB and the OTS have been bound at 1902, a credit card account associated with the buyer is charged the price of the item along with a commission amount at 1904.

If the seller has not requested a cash advance at 1906, the controller 100 waits seven days at 1910 (e.g., to allow the buyer to submit a claim) and credits a credit card account associated with the seller price of the item less a commission amount at 1912. If the seller had requested a cash advance at 1906, the controller 100 may immediately provide the payment to the seller, perhaps less an additional fee at 1908.

Moreover, if a buyer claim is approved at 1914 (e.g., the item provided by the seller does not work properly), the price of the item may be refunded from the seller to the buyer.

FIG. 20 is a flow chart of a method performed when an offer to sell is bound with an offer to buy according to another embodiment of the present invention. In particular, FIG. 20 illustrates a determination of whether one or more databases stored at the controller 100 should be updated. When the OTB and the OTS are bound at 1202, the status 1216 in the offer to sell database 1200 and the status 1114 in the offer to buy database 1100 are updated to “filled” at 2024 and 2006, respectively.

When a transfer code is received from the seller (indicating that he or she did in fact provide the item to the buyer) at 2008, the transfer code may be stored in the transaction database 1300 at 2010. In addition, the status 1216 in the offer to sell database 1200 and the status 1114 in the offer to buy database 1100 are updated to “complete” at 2012 and 2014, respectively.

### ADDITIONAL EMBODIMENTS

The following are several examples which illustrate additional embodiments of the present invention. These examples do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

In one embodiment, the buyer pays the seller directly rather than paying the controller 100 and having the controller 100 pay the seller. In this case, the controller 100 may still generate a transfer code for the buyer to give to the seller. The seller uses the transfer code as a receipt for having given the item to the buyer. The seller may then submit the code to the controller 100 to avoid a fine and to inform the controller 100 that the transaction has been completed. The controller 100 may also give the seller a transfer code. In this case, the seller gives the seller code to the buyer when the buyer provides payment, and the buyer thereby has a receipt for having paid for the item. The buyer can submit the seller code to the controller 100 to avoid a fine and to inform the controller 100 that the transaction has been completed. Note that, even when the buyer has paid the seller directly, the buyer can still get a refund from the controller 100 rather than the seller, and leave it up to the controller 100 to receive a refund from the seller.

In another embodiment, the controller 100 may use operators, associated with the transaction system 700, to act as buyers or sellers in a transaction. The operators will then be able to detect fraud attempts by the other party. Using such an operator avoids a situation where one party commits fraud, but the controller 100 only has the other party's word for it.

In one embodiment, the buyer may allow third parties (e.g., friends or relatives) to receive an item on his or her behalf. Thus, in a shipping embodiment, the item may be shipped to a third party's address. In a direct transfer embodiment, a third party's address may expand the geographic range to which a seller may drive. For example, in determining a location for the buyer and seller to meet, the controller 100 might choose a location farther than an acceptable distance from the buyer, but near to the third party.

In one embodiment, the buyer may transmit the transfer code directly back to the controller 100, such as when the controller 100 has some way of knowing that the buyer and seller have transacted. For example, if the buyer and seller are together for the purposes of completing a transaction, the seller may log onto Web site and allow the buyer to type in the transfer code directly. The controller may determine since the seller was the one to log on, the buyer and seller must be together and must have completed the transaction.

According to another embodiment, buyer and seller behavior may be tracked in order to protect the controller 100 from misconduct. By tracking buyer and seller behavior, the controller 100 may apply penalties to buyers and sellers who fail to meet obligations, abuse privileges, attempt fraud, or otherwise misbehave. Similar to a system used in sports, a “yellow card” may be given for minor misconduct or a warning, and a “red card” may be given for more serious misconduct. By way of example, a yellow card may indicate that:
A seller cannot receive cash advances on a sold item.
A buyer or seller cannot use a particular credit card account for a period of time with transaction system 700 (a “time-out”). If enough time-outs are accrued to a buyer or seller, the buyer or seller might permanently lose privileges, including the ability to use transaction system 700, possibly indicated by a red card.
A buyer or seller cannot use any credit card account with the transaction system 700 for a period of time. Buyer and seller names and billing addresses could be linked with credit card accounts so that a buyer or a seller would not be able to switch from using one credit card account to another.

A red card may indicate that a buyer or seller can never again use the transaction system.

Penalties, such as a yellow card, may be applied in any number of ways. For example, there may be several levels of penalty. In the above example, there are two levels (i.e., a yellow card and a red card). There may be predetermined rules for how a buyer or seller may achieve a penalty level. For example, serious misconduct may skip penalty levels (e.g., skip the yellow card and go to red). On the other hand, it may take many instances of minor misconduct to achieve even a first penalty level, such as a yellow card. There may be multiple “shades” of a penalty level. For example, one shade of yellow card might restrict a buyer from buying anything for more than $50, while another shade might restrict a buyer from making warranty claims. The difference in penalties for the shades may reflect a tailoring of the penalty towards the variety of misconduct. For example, the buyer who is restricted in his purchase price may have demonstrated bad credit. Further demonstrations of misconduct, from any shade of one penalty level, may all lead to the next penalty level, which may or may not have its own shades. Through demonstration of good behavior over a period of time or transactions, a buyer or seller may step down one or more penalty levels.

According to one embodiment, a seller transmits information about an item via the transaction system 700 and registers a charity to which he or she would like to donate the item. In this case, funds may be transferred to the charity rather than to the seller as payment for the item. The controller 100 informs the seller of the sale price, and issues a donation form to the seller for tax purposes. The donation form may be issued after every donation, or may be issued at the end of the year to aggregate donations. The controller 100 may verify to the Internal Revenue Service, or other government agency, that it does nothing to alter the fair market value of the item for sale, and thus complies with the appropriate tax law and/or regulations. Note that, according to one embodiment, the “charity” may comprise a friend or family member associated with a party (e.g., the buyer or the seller).

In one embodiment, a seller possesses at least two credit card accounts accessible to the controller 100. Immediately after binding, a first seller credit card is credited with the price of the sold item, minus any commission or fees. At the same time, funds equal to the price of the item, plus a penalty, are frozen on a second seller credit card. If the controller 100 receives a transfer code, an indication of buyer satisfaction, or some other indication that the seller delivered the item, then funds may be unfrozen on the seller's second credit card. Otherwise, the price of the item, and possibly a penalty, may be deducted from the frozen funds on the second seller credit card.

According to another embodiment, a buyer satisfaction code is sent to a buyer. The buyer satisfaction code may be, for example, identical to the transfer code. However, the buyer satisfaction code is submitted to the controller 100 by the buyer in order to show satisfaction with the item. The buyer satisfaction code may allow the system to avoid authenticating the buyer's identity when the buyer indicates satisfaction. The code itself authenticates the buyer's identity because the buyer and possibly the seller, are the only people who possess the code.

According to another embodiment, a seller may be paid at different points based on his or her previous experience with the controller 100. For example, a first time seller may be paid only after submitting a transfer code, or after the buyer indicates that he received the item. A second time seller might be paid immediately after binding. A fifth time seller may be paid the offer price before the item is even sold.

In one embodiment, a buyer may inspect an item associated with an OTS before the buyer is bound to buy the item. To inspect the item, the buyer may meet the seller, or the seller may ship the item to the buyer. There may be a time limit on how long the buyer takes to inspect the item. If the buyer has not rejected that item within the time limit, the buyer may become bound to buy the item. The buyer may reject the item by, for example, entering a cancel code into a Web site. For every item the buyer rejects, he or she may be charged a fee. After the buyer rejects one item, he or she may be matched to a new item, the new item being different from any item the buyer previously rejected. There may be a limit on the number of items a buyer can reject before being barred from using the controller 100 or otherwise penalized.

After rejecting an item, a buyer may be required to fill out a survey to describe his or her reasons for rejecting the item. If the buyer indicates that the item was faulty or defective, then the seller of that item may be prohibited from selling that item to any other buyer. Also, if a seller's item is rejected by a predetermined number of buyers, the seller may be prohibited from selling that item.

According to some embodiments, an action is performed a “predetermined amount of time” after some other action. The amount of time waited before performing a particular action, however, need not be fixed or predetermined. For example, the amount of time waited after binding before paying the seller may depend on the seller's prior experience with the controller 100, or the fragility of the item being sold. Other factors that may be used to determine an amount of time before performing an action include: the price of the item; the reasonableness of an OTB or OTS; the method of transfer; the date; the buyer or seller credit history; the buyer's address, the seller's address, or a meeting location; the success of previous transactions involving related items; and/or the novelty of the market.

The controller 100 may add or adjust peripheral benefits associated with an item for sale. These benefits may include, for example, warranty plans, finance options, maintenance deals, and cash advances. The controller 100 may also adjust the amount of commissions collected from a buyer or a seller. The adjustments may be based on a number of factors, including: the price of the item; the reasonableness of an OTB or OTS; the method of transfer; the date; the buyer or seller credit history; the buyer's address, the seller's address, or meeting location; the success of previous transactions involving related items; or the novelty of the market; and/or deals with third parties. For example, a deal with an automobile parts dealer may enable the controller 100 to charge lower commissions in exchange for the dealer handling warranty claims.

The times the controller 100 waits, and the peripheral benefits the controller 100 confers, may not only be variable, but be adjustable for identical circumstances. For example, transactions on two consecutive days might involve similar items, a similar geographic region, and/or similar times of day. However, the controller 100 may adjust the warranty offered from the first day to the next to test profitability, or customer acceptance. It may be a human representative of the controller 100 making the adjustments, or the adjustments may be made automatically. The adjustments may also proceed in accordance with an evolutionary system. For example, the controller 100 may track transactions from a particular geographic location, find that numerous warranty claims stem from that region, and thus automatically increase the amount of time before a seller gets paid for an item in that region.

In some embodiments, the controller 100 may employ, or partner with, an authenticator. The authenticator may participate in transactions by validating the condition, or the authenticity of an item. In one embodiment, the buyer and seller transfer the item at the location of an authenticator. The authenticator may examine the item before the item is passed to the buyer, and may assist the buyer in rejecting a faulty item. The authenticator may receive an authentication code from the buyer, the seller, or the controller 100, and subsequently communicate that code to the controller 100 in order to deem the item authentic.

After a buyer claim or complaint has been approved, there are several ways to resolve the buyer's problem. One method mentioned above is for the buyer to keep the item, but receive a partial refund. In offering this action to the buyer, the controller 100 faces the question of how much of a refund to offer. The controller 100 may keep a list of criteria to consider in offering a partial refund, these criteria possibly including, the price of the item, the effort required to return the item, the item's condition, and/or the buyer and seller histories. For example, if the item is in poor condition, the controller 100 may offer a refund equal to a large percentage of the price the buyer paid. Each criterion may receive a transaction-specific numerical value and a predetermined or dynamically adjusting weighting factor. For example, the condition of an item is rated on a scale of 1 to 10, and a weighting factor of 0.5 is applied to the criterion. Summing the criteria values with applied weighting factors may result in a quantitative amount of refund to offer. The controller 100 may cover expenses associated with reversing a transaction by paying the buyer a smaller refund than is collected from the seller. Thus, differing weighting scales may determine how much to refund the buyer versus how much to take back from the seller.

According to another embodiment, a buyer or a seller may have date dependent transfer preferences. For example, a buyer might agree to personal transfers in January, but only to shipping afterwards. Similarly, a female buyer may prefer to meet a female seller in person and prefer to have a male seller ship an item to a third party (e.g., a MAILBOXES ETC.® store).

According to another embodiment, a buyer and/or seller receives a benefit in exchange for following instructions (e.g., a seller may be given a reward when he or she supplies a delivery code within a predetermined period of time).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating a transaction between a seller interested in selling a secondary market item and a buyer interested in making a purchase, comprising:
receiving a binding seller offer, including a seller address, associated with the item;
receiving a binding buyer offer, including a buyer address, associated with the buyer;
matching the binding seller offer and the binding buyer offer based at least in part on the seller address and the buyer address;
arranging for the buyer to purchase the item from the seller;
transmitting a transfer code to the buyer after the buyer has provided payment for the item;
transmitting verification information to the seller enabling the seller to validate the transfer code;
receiving the transfer code from the seller as an indication that the buyer has received the item; and
after said receiving, arranging for the seller to receive payment in exchange for providing the item to the buyer,
wherein at least one of said transmitting the transfer code to the buyer and said receiving the transfer code from the seller are performed via a communications network.

2. A method of facilitating a transaction between a seller interested in selling an item and a buyer interested in making a purchase, comprising:
transmitting a first transfer code to the buyer;
receiving a second transfer code from the seller as an indication that the buyer has received the item, the second transfer code being associated with the first transfer code; and
after said receiving, arranging for the seller to receive payment in exchange for providing the item to the buyer.

3. A computer readable medium storing instructions for facilitating a transaction configured to direct a processor to:
transmit a first transfer code to the buyer;
receive a second transfer code from the seller as an indication that the buyer has received the item, the second transfer code being associated with the first transfer code; and
after receiving, arranging for the seller to receive payment in exchange for providing the item to the buyer.

4. A method for completing a transaction with a seller interested in selling an item, comprising:
arranging via a controller to purchase the item from the seller;
arranging to provide payment for the item;
after said arranging to provide payment, receiving a transfer code from the controller;
receiving the item from the seller; and
after said receiving the item, transmitting the transfer code to the seller as an indication that the seller has provided the item.

5. A method for completing a transaction with a buyer interested in making a purchase, comprising:
arranging via a controller to sell an item to the buyer;
providing the item to the buyer;
after said providing, receiving a transfer code from the buyer;
transmitting the transfer code to the controller as an indication that the item has been received by the buyer; and
after said transmitting, receiving payment in exchange for providing the item to the buyer.

6. The method of claim 5, further comprising:
verifying the transfer code received from the buyer.

7. The method of claim 6, wherein said verifying comprises:
verifying the transfer code based on verification information received from the controller prior to said receiving the transfer code.

8. The method of claim 6, wherein said verifying comprises:
verifying the transfer code based on verification information received from the controller in response to a verification request sent to the controller after said receiving the transfer code.

9. A computer readable medium storing instructions for facilitating a transaction configured to direct a processor to:
arrange via a controller to sell an item to a buyer;
arrange for the item to be provided to the buyer;
receive a transfer code from the buyer;
transmit the transfer code to the controller as an indication that the item has been received by the buyer; and
receive an indication that payment was made in exchange for the item being provided to the buyer.

10. A method of facilitating a transaction between a seller interested in selling an item and a buyer interested in making a purchase, comprising:
arranging for the buyer to purchase the item from the seller;
transmitting a transfer code to the seller;
receiving the transfer code from the buyer; and
arranging for the seller to receive payment in exchange for providing the item to the buyer.

11. A method of facilitating a transaction between a seller interested in selling an item and a buyer interested in making a purchase, comprising:
arranging for the buyer to purchase the item from the seller;
receiving a delivery code from the seller; and
after said receiving, arranging for the seller to receive payment in exchange for providing the item to the buyer.

12. The method of claim 11, further comprising:
verifying the delivery code.

13. The method of claim 11, further comprising:
prior to said arranging, verifying that the buyer has received a delivery associated with the delivery code.

14. The method of claim 11, further comprising:
based on said receiving, providing a benefit to the seller.

15. A method of facilitating a transaction between a seller interested in selling an item and a buyer interested in making a purchase, comprising:
receiving information associated with the transaction;
transmitting a transfer code to the buyer after the buyer has provided payment for the item;
receiving the transfer code from the seller as an indication that the buyer has received the item; and
after receiving the transfer code from the seller, arranging for the seller to receive payment in exchange for providing the item to the buyer.

16. A method of facilitating a transaction between a seller interested in selling an item and a buyer interested in making a purchase, comprising:
receiving an indication of a first preferred method of delivery from the seller;
receiving an indication of a second preferred method of delivery from the buyer; and
based on the first preferred method of delivery and the second preferred method of delivery, arranging for the buyer to purchase the item from the seller.

17. The method of claim 16, wherein the first preferred method of delivery is associated with a first location and a first maximum distance, the second preferred method of delivery is associated with a second location and a second maximum distance, and said arranging comprises:
determining a third location based on the first location, the first maximum distance, the second location, and the second maximum distance.

18. The method of claim 16, further comprising:
based on the first preferred method of delivery and the second preferred method of delivery, arranging for the item to be delivered to the buyer.

19. A computer readable medium storing instructions for facilitating a transaction configured to direct a processor to:
receive an indication of a first preferred method of delivery from the seller;
receive an indication of a second preferred method of delivery from the buyer; and
arrange, based on the first preferred method of delivery and the second preferred method of delivery, for the buyer to purchase the item from the seller.

20. A method of facilitating a transaction between a seller interested in selling an item and a buyer interested in making a purchase, comprising:
arranging for the buyer to purchase the item from the seller;
receiving complaint information from at least one of the buyer and the seller; and
based on the received complaint information, applying a penalty to at least one of the buyer and the seller.

21. The method of claim 20, wherein said receiving comprises:
providing a prompt requesting the complaint information; and
receiving the complaint information in response to the prompt.

22. A computer readable medium storing instructions for facilitating a transaction configured to direct a processor to:
arrange for a buyer to purchase the item from the seller;
receive complaint information from at least one of the buyer and a seller; and
apply a penalty, based on the received complaint information, to at least one of the buyer and the seller.

23. A medium storing instructions adapted to be executed by a processor to perform a method for facilitating a transaction, said method comprising:
arranging for the buyer to purchase the item from the seller;
transmitting a transfer code to the buyer after the buyer has provided payment for the item;
receiving the transfer code from the seller as an indication that the buyer has received the item; and
after said receiving, arranging for the seller to receive payment in exchange for providing the item to the buyer.
